(19) United States
(12) Patent Application Publication
(10) Pub. No.: US 2025/0301209 A1
(43) Pub. Date: Sep. 25, 2025

(54) IMAGE SENSOR AND IMAGE INSPECTION SYSTEM

(71) Applicant: Keyence Corporation, Osaka (JP)

(72) Inventors: Shunsuke HAYASHI, Osaka (JP); Yuuki UMEZAKI, Osaka (JP)

(73) Assignee: Keyence Corporation, Osaka (JP)

(21) Appl. No.: 19/049,048

(22) Filed: Feb. 10, 2025

(30) Foreign Application Priority Data
Mar. 19, 2024 (JP) 2024-043873

(51) Int. Cl. H04N 23/52; H04N 23/51; H04N 23/54; H04N 23/56

(52) U.S. Cl. CPC H04N 23/52; H04N 23/51; H04N 23/54; H04N 23/56

(57) ABSTRACT

Provided is an image sensor that suppresses an increase in size and a rise of a sensible temperature of a user. The image sensor includes a cover member that covers at least a part of each of a pair of side surfaces that are not adjacent to each other but is adjacent to a front surface including an imaging hole configured to guide light outside an image sensor housing to the image sensor. The cover member is made of a material having a lower thermal conductivity than that of the image sensor housing. The image sensor housing includes a contact portion integrally formed with the image sensor housing. The contact portion comes into contact with a prop when the image sensor housing is attached to the prop.

### CROSS-REFERENCE TO RELATED APPLICATIONS

The present application claims foreign priority based on Japanese Patent Application No. 2024-043873, filed Mar. 19, 2024, the contents of which are incorporated herein by reference.

### BACKGROUND OF THE INVENTION

### 1. Technical Field

The invention relates to an image sensor and an image inspection system.

### 2. Description of the Related Art

In an image sensor disclosed in JP 2017-76168 A, resolution of an image is increased in order to output a sensor according to a fine visual characteristic.

In the image sensor, a component having a large amount of heat generation, such as an inference accelerator for performing calculation processing (execution of an AI function) by a model of a network structure at high speed, is used in order to process a high-resolution image at high speed.

### SUMMARY OF THE INVENTION

In a case where the component having a large amount of heat generation is used, in a conventional heat dissipation measure in which heat generated inside is thermally conducted to a metal housing, a housing temperature (outer surface temperature) increases as compared with the related art. As a result, a sensible temperature when a user grips the housing becomes high, and there is a possibility that the convenience of the user deteriorates. In addition, since the sensible temperature at the time of gripping is higher than that of a conventional image sensor there is a concern that the user may erroneously recognize an abnormality.

In addition, a method is also conceivable in which a housing temperature is lowered by increasing a size of a housing to increase a heat dissipation area and the amount of heat dissipation, thereby lowering a sensible temperature when a user grips the housing. However, when the housing is increased in size, constraints on installation of an image sensor increase, and there is a possibility that the convenience deteriorates.

In view of the above problems, the present disclosure provides an image sensor capable of suppressing an increase in size and suppressing a rise of a sensible temperature of a user.

According to one embodiment, an image sensor captures an image of an object to be inspected. An image sensor includes: an imaging unit including an imaging sensor; a control unit that processes a captured image captured by the imaging unit; an image sensor housing that is made of metal, houses the imaging unit and the control unit, and is attachable to a prop; and a cover member that is made of a material having a thermal conductivity lower than that of the image sensor housing and covers at least a part of each of a pair of side surfaces, which are surfaces intersecting a front surface and facing in mutually different directions, the front surface being a surface including an imaging hole configured to guide light outside the image sensor housing to the imaging sensor. The image sensor housing includes a contact portion that comes into contact with the prop when the image sensor housing is attached to the prop.

According to the invention, it is possible to provide the image sensor that suppresses the increase in size and the rise of the sensible temperature of the user.

### BRIEF DESCRIPTION OF THE DRAWINGS

FIG. 1 is a diagram illustrating an operation state of an image inspection system according to an embodiment of the invention;

FIG. 2 is a hardware configuration diagram of the image inspection system;

FIG. 3 is a perspective view of an image sensor as viewed from an upper rear side;

FIG. 4 is a perspective view of the image sensor as viewed from an upper front side;

FIG. 5 is a front view of the image sensor;

FIG. 6 is a rear view of the image sensor;

FIG. 7 is a top view of the image sensor;

FIG. 8 is a bottom view of the image sensor;

FIG. 9 is a left side view of the image sensor;

FIG. 10 is a right side view of the image sensor;

FIG. 11 is a rear view of the image sensor;

FIG. 12 is a cross-sectional view taken along line XII-XII of the image sensor illustrated in FIG. 11;

FIG. 13 is a perspective view of the image sensor in a state in which a rear sensor connector lid provided on a rear surface of the image sensor is opened as viewed from the upper rear side;

FIG. 14 is a perspective view of the image sensor in a state in which a cover member and the rear sensor connector lid are separated as viewed from the upper rear side;

FIG. 15 is a perspective view of the image sensor in a state in which a front sensor connector lid is opened as viewed from a lower front side;

FIG. 16 is a view of the rear sensor connector lid as viewed from an inner surface side;

FIG. 17 is a view of the front sensor connector lid as viewed from an inner surface side;

FIG. 18 is a perspective view of the image sensor in a state in which an external connection portion is moved to a second position as viewed from the upper rear side;

FIG. 19 is a block diagram of the image sensor to which a communication unit is attached;

FIG. 20 is a perspective view of the image sensor in a state in which the communication unit is attached as viewed from the upper rear side;

FIG. 21 is a cross-sectional view of the image sensor in the state in which the communication unit is attached;

FIG. 22 is a perspective view illustrating a state in which the communication unit is separated from the image sensor;

FIG. 23 is a perspective view of the communication unit as viewed from the upper rear side;

FIG. 24 is a perspective view of the communication unit from which a communication unit cover member is separated as viewed from the upper rear side;

FIG. 25 is a perspective view of the communication unit in a state in which an external communication connection portion is moved to a fourth position as viewed from the upper rear side;

FIG. 26 is a perspective view illustrating a state in which the image sensor with the external connection portion moved to the second position is combined with the communication unit with the external communication connection portion moved to the fourth position;

FIG. 27 is a flowchart of an operation of setting the communication unit;

FIG. 28 is a view illustrating a setting screen displayed on a display device when extended setting of the image sensor is performed;

FIG. 29 is a view illustrating the setting screen when the communication unit is connected;

FIG. 30 is a diagram illustrating a detailed setting screen used when setting of the communication unit is performed;

FIG. 31 is a schematic diagram of an image inspection system connected in a first network connection example;

FIG. 32 is a schematic diagram of an image inspection system connected in a second network connection example;

FIG. 33 is a schematic diagram of an image inspection system connected in a third network connection example;

FIG. 34 is a block diagram illustrating communication between a controller of the image sensor and a controller of the communication unit;

FIG. 35 is a schematic diagram of an image inspection system connected in a fourth network connection example; and

FIG. 36 is a schematic diagram of an image inspection system connected in a fifth network connection example.

### DETAILED DESCRIPTION

Hereinafter, an embodiment of the invention will be described in detail with reference to the drawings. Note that the following preferred embodiment is described merely as an example in essence, and there is no intention to limit the invention, its application, or its use.

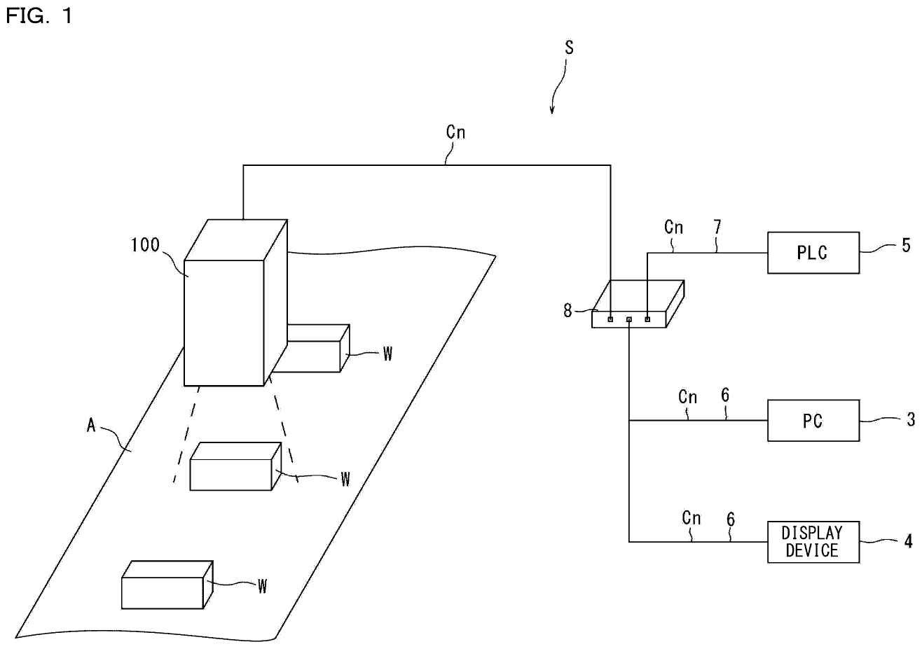

FIG. 1 is a diagram illustrating an operation state of an image inspection system S according to the embodiment of the invention. For example, the image inspection system S captures an image of a workpiece W, which is an object to be inspected conveyed by a conveyance unit A, according to an imaging setting to acquire inference image data, detects the workpiece W in the image of the acquired inference image data, and outputs a detection result to an external device. Examples of the external device include a programmable logic controller (PLC) 5, but a device other than the PLC 5 may be used as the external device. Based on the received detection result, the PLC 5 controls the conveyance unit A so as to separate a storage destination of the workpiece W, for example. In the following description, a case where the external device is the PLC 5 will be described. Note that the workpiece W may be a workpiece that is not conveyed by the conveyance unit A. In the following description, a workpiece is also referred to as an object.

The image inspection system S includes an image sensor 100, a personal computer (PC) 3, a display device 4, and the PLC 5. The image sensor 100 includes an imaging unit 1 configured to capture the image of the workpiece W, and a control unit 2 to which the inference image data captured by the imaging unit 1 is input. The image sensor 100 is an integrated device incorporating the imaging unit 1 and the control unit 2. The image sensor 100 includes an external connection portion 300.

The PC 3 performs setting of the image inspection system S, the image sensor 100, and the like. The display device 4 displays a setting screen, a selection screen, the workpiece image, the detection result, and the like. The control unit 2 can execute a trained model that detects the workpiece W in the image of the input inference image data. The control unit 2 executes output corresponding to the detection result by the trained model with respect to the PLC 5.

Here, the image inspection system S is sometimes used, for example, for inspecting the workpiece W from various angles at each point of a manufacturing apparatus and a manufacturing line. For this reason, a plurality of the image inspection systems S may be installed in one manufacturing apparatus or one manufacturing line, and it is conceivable that an installation space and a supply power source cannot be sufficiently secured. Therefore, the image inspection system S is required to be downsized in accordance with the installation space and achieve power saving in accordance with the supply power source. In order to satisfy these requirements, the image inspection system S according to the present embodiment does not include a GPU.

The image inspection system S executes a model created by a machine learning method so as to be suitable for detecting the workpiece W, and is provided to a user in a state in which most of calculation required to obtain the model is completed by a provider who provides the image inspection system S to the user. In the present specification, machine learning performed by the provider prior to provision to the user is referred to as preliminary learning, and the model created by the preliminary learning is referred to as a preliminarily trained model. That is, although the control unit 2 executes the model that has been trained to such an extent that the workpiece W can be detected, it is possible to obtain desired detection accuracy even if the user does not perform advanced machine learning for which the use of a GPU is recommended. Since the user does not need to perform the advanced machine learning, the user can execute the model capable of detecting the workpiece W without preparing a GPU adapted to learning. Alternatively, it is possible to shorten a time required to prepare the model capable of detecting the workpiece W. Note that the image inspection system S installed in a manufacturing apparatus or a manufacturing line may include one image sensor 100 or may include a plurality of the image sensors 100. The image inspection system S illustrated in FIG. 1 includes one image sensor 100.

### Configuration of Imaging Unit 1

The imaging unit 1 is installed so as to be capable of capturing an image of the workpiece W from a desired direction. The workpiece W is sequentially conveyed by the conveyance unit A to an imaging field of view of the imaging unit 1.

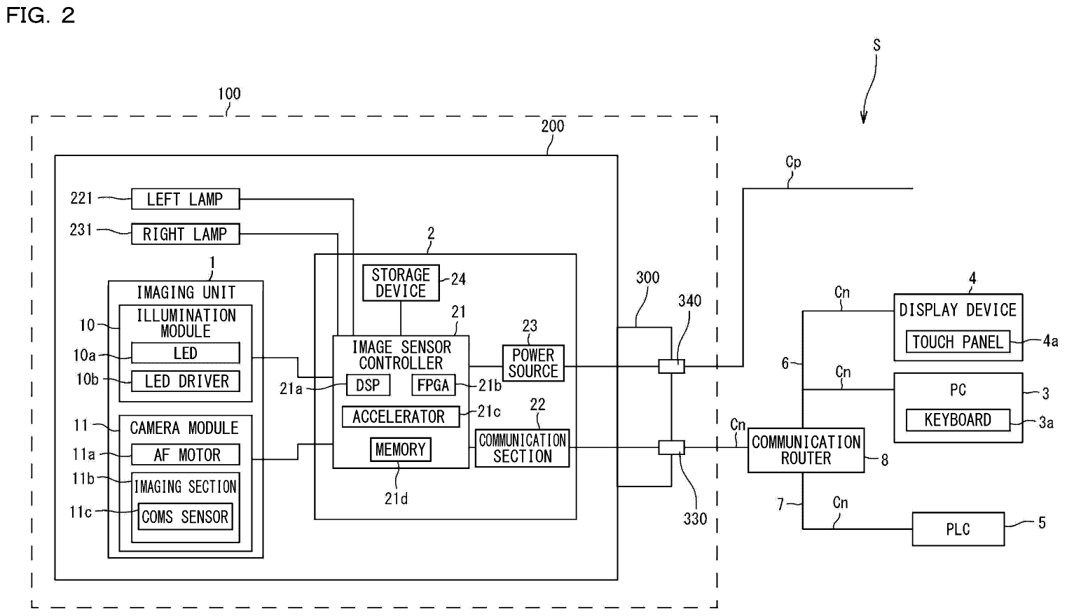

As illustrated in FIG. 2, the imaging unit 1 includes an illumination module 10 configured to illuminate the workpiece W and a camera module 11 configured to capture the image of the workpiece W illuminated by the illumination module 10.

The illumination module 10 includes a light emitting diode (LED) 10a that irradiates the workpiece W with light, and an LED driver 10b that controls a light amount, a light emission timing, and the like of the LED 10a. The LED driver 10b is connected to the control unit 2 and is controlled by an image sensor controller 21 of the control unit 2.

The camera module 11 includes an AF motor 11a and an imaging section 11b. The AF motor 11a drives an optical lens (not illustrated) constituting a lens section 11f. A position of the optical lens is adjusted by driving the AF motor 11a. As a result, the workpiece W is automatically focused. A method for autofocus is not particularly limited, and examples thereof include a contrast method.

The imaging section 11b includes a CMOS sensor 11c. The CMOS sensor 11c is an image sensor that receives reflection light emitted from the LED 10a to the workpiece W and reflected by the workpiece W. The CMOS sensor 11c is connected to the image sensor controller 21 of the control unit 2, and is controlled by the image sensor controller 21 of the control unit 2 to perform exposure processing at a predetermined timing for a predetermined time.

### Configuration of Control Unit 2

The control unit 2 is provided in the image sensor 100 together with the imaging unit 1, and is connected to the imaging unit 1 so as to enable mutual transmission and reception of power, signals, and data. The control unit 2 includes the image sensor controller 21, a communication section 22, a power source 23, and a storage device (storage unit) 24. A control signal of the imaging unit 1 output from the image sensor controller 21 is transmitted to the imaging unit 1. The control signal of the imaging unit 1 includes a signal for controlling a light emission timing and a light emission amount of the LED 10a, and a signal for controlling the AF motor 11a and the imaging section 11b. In addition, image data acquired by the imaging unit 1 is transmitted from the imaging unit 1 to the image sensor controller 21 of the control unit 2.

The image sensor controller 21 includes a DSP 21a and an FPGA 21b that execute various types of signal processing, an accelerator 21c configured to speed up processing, and a memory 21d including a RAM, a ROM, and the like.

The DSP 21a is a signal processing device. The FPGA 21b is a processing device capable of changing the content of internal processing. A light reception amount signal of a light receiving element included in the CMOS sensor 11c is output to the FPGA 21b and processed, and is also output from the FPGA 21b to the DSP 21a and processed. Although the processing by the DSP 21a and the FPGA 21b is not particularly limited, for example, various types of filter processing, processing of detecting the workpiece W from the image data, and processing and inspection of the workpiece W obtained from the image data such as processing of determining whether or not work performed on the detected workpiece W is appropriate (quality determination), are performed. In addition, the DSP 21a and the FPGA 21b can also execute processing other than these on the workpiece W. Note that the control unit 2 includes the DSP 21a and the FPGA 21b in the present embodiment, but similar DSP and FPGA may be provided in the imaging unit.

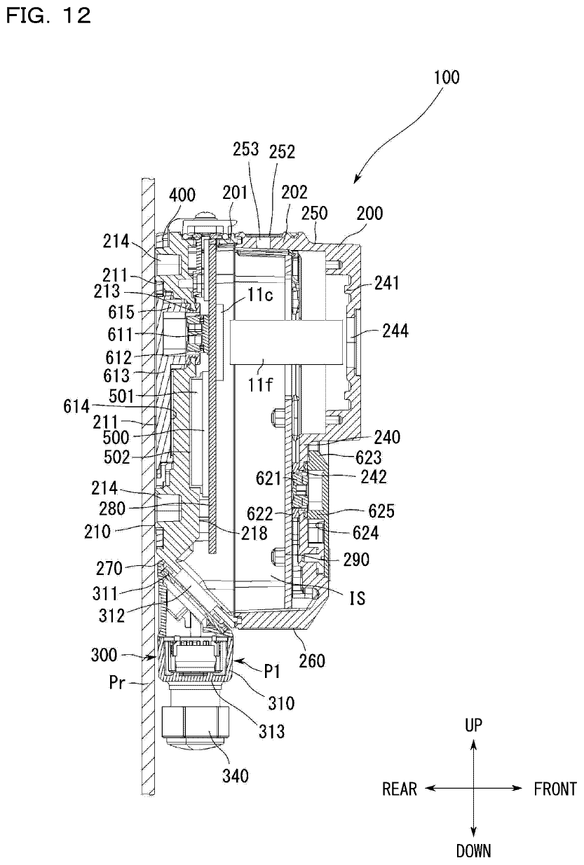

The communication section 22 executes data communication to be transmitted and received by the image sensor controller 21. The communication section 22 is connected to an external connection plug 330 of the external connection portion 300. A communication cable Cn, connected to the PC 3, the display device 4, and the PLC 5, is connected to the external connection plug 330. The communication section 22 enables mutual data communication among the image sensor controller 21 and the PC 3, the display device 4, and the PLC 5. In addition, the communication section 22 transmits a result of inspection on the image data executed by the image sensor controller 21 to the PLC 5. That is, the control unit 2 executes sensor output of processing data obtained by processing a captured image captured by the imaging unit 1 by the image sensor controller 21. Note that the image sensor controller 21 may be provided as a semiconductor element configured by one chip, for example, an IC 500 (see FIG. 12). The IC 500 is a heating element of the image sensor 100.

The external connection portion 300 includes the external connection plug 330 to which the communication cable Cn connected to an external device is connected, and an external connection plug 340 to which a power cable Cp is connected. The external connection plug 330 is connected to the communication section 22 and communicates with the PC 3, the display device 4, and the PLC 5 via the communication cable Cn. In addition, the external connection plug 340 is connected to the power source 23, and power is supplied via the power cable Cp. Note that the image sensor 100, the PC 3, the display device 4, and the PLC 5 are connected via a communication router 8. That is, the image sensor 100, the PC 3, the display device 4, and the PLC 5 are all connected to the communication router 8 via the communication cable Cn.

Note that the communication cable includes a communication cable capable of performing data communication and power supply. When the communication cable capable of power supply and data communication is connected to the external connection plug 330, both the external connection plugs 330 and 340 can adopt a configuration capable of performing communication and power supply.

### Configuration of PC

The PC 3 is configured by a general-purpose personal computer or the like. In this example, the PC 3 can be used by installing a predetermined program in the personal computer. The PC 3 includes operation devices such as a keyboard 3a and a mouse (not illustrated). The user of the image inspection system S can perform a setting operation and a selection operation of the image inspection system S by operating the operation devices of the PC 3. Specific setting operation and selection operation will be described later.

The PC 3 and the image sensor 100 are connected to be capable of communicating with each other, and data based on the setting operation by the user is transmitted from the PC 3 to the image sensor 100. The PC 3 can receive the image data of the workpiece W, the inspection result, and the like output from the image sensor 100. The PC 3 and the image sensor 100 are connected via the communication cable Cn. Thus, the PC 3 can be installed at a place away from an installation place of the image sensor 100.

### Configuration of Display Device 4

The display device 4 is configured by, for example, a liquid crystal display, an organic EL display, or the like. In this example, the display device 4 includes a touch panel 4a. The touch panel 4a is a member capable of detecting an operation by the user's fingers. The type of the touch panel 4a is not particularly limited, and examples thereof include a capacitance type and an infrared type.

The display device 4 and the image sensor 100 are connected to be capable of communicating with each other. Data based on the user's operation on the touch panel 4a is transmitted from the display device 4 to the image sensor 100. The display device 4 can receive the image data of the workpiece W output from the image sensor 100. The display device 4 and the image sensor 100 are connected via the communication cable Cn. Thus, the display device 4 can be installed at a place spaced apart from the installation place of the image sensor 100.

Note that the PC 3 and the display device 4 may be integrally configured. For example, the display device 4 may be configured by a display device included in the PC 3. In this case, a main body portion of the PC 3 and the display device 4 may be integrated with each other or may be separated from each other. In this example, the image sensor 100 and the PLC 5 are connected via the communication cable Cn.

### Configuration of Image Sensor 100

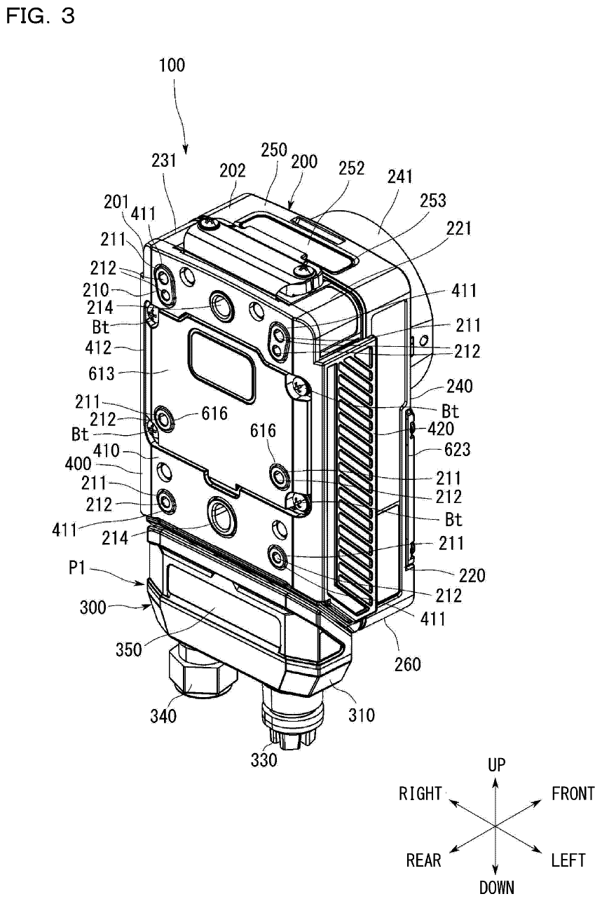

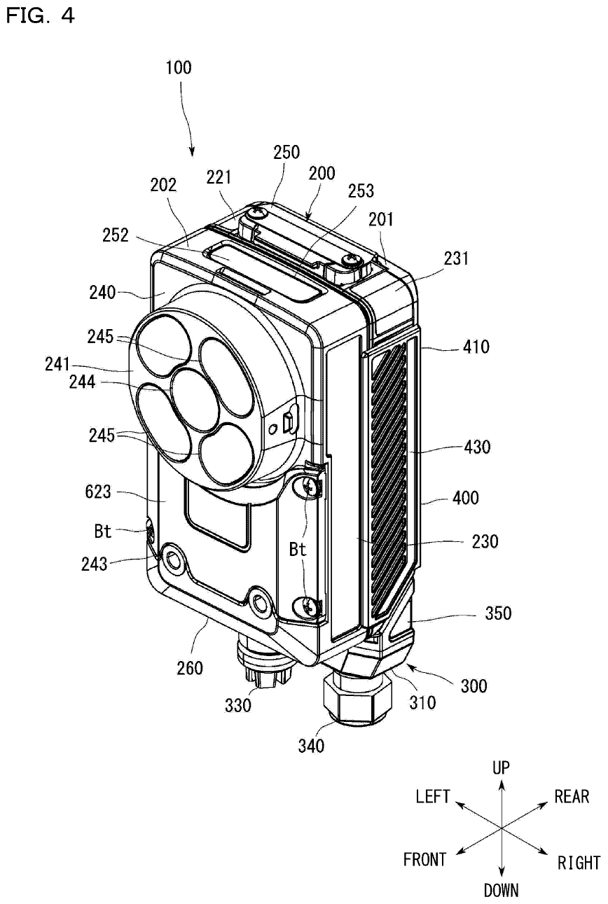

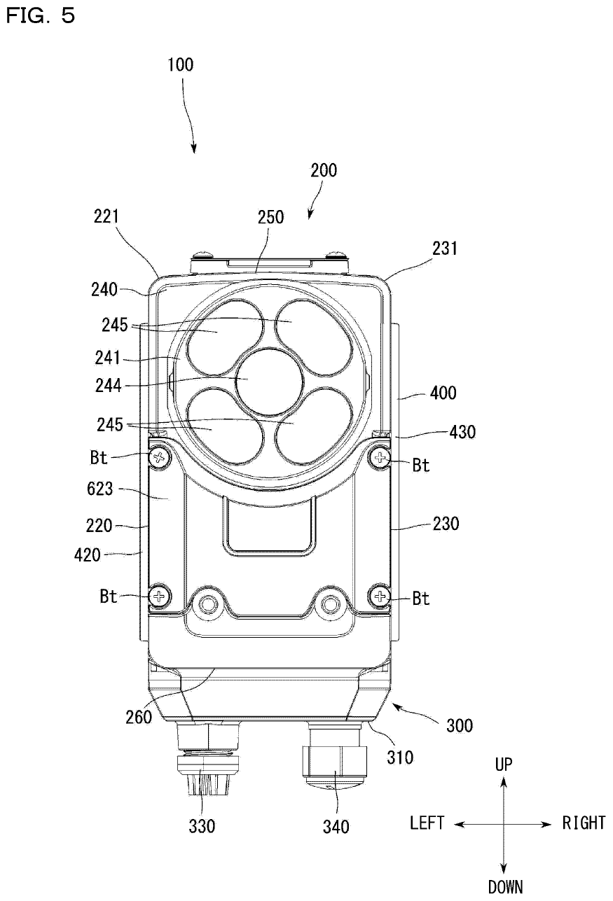

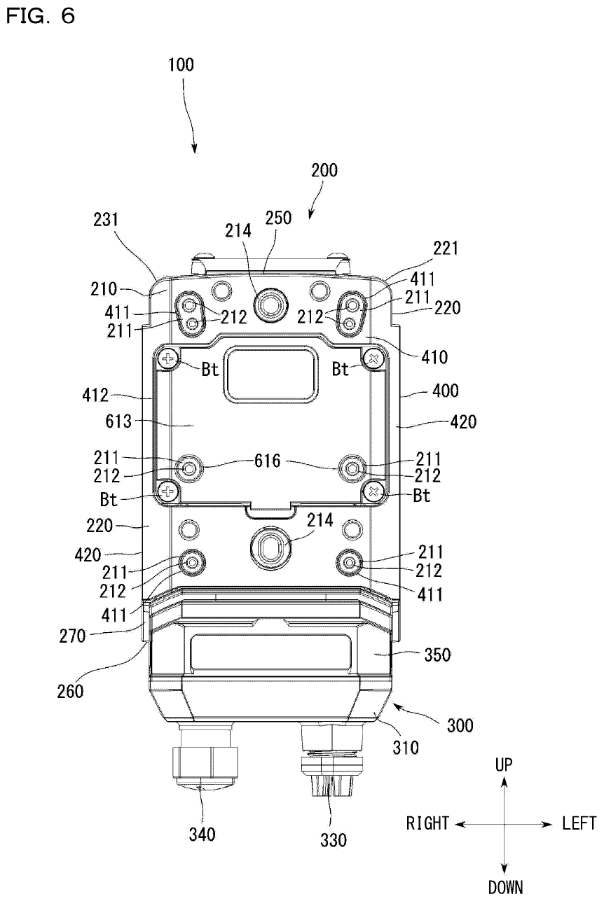

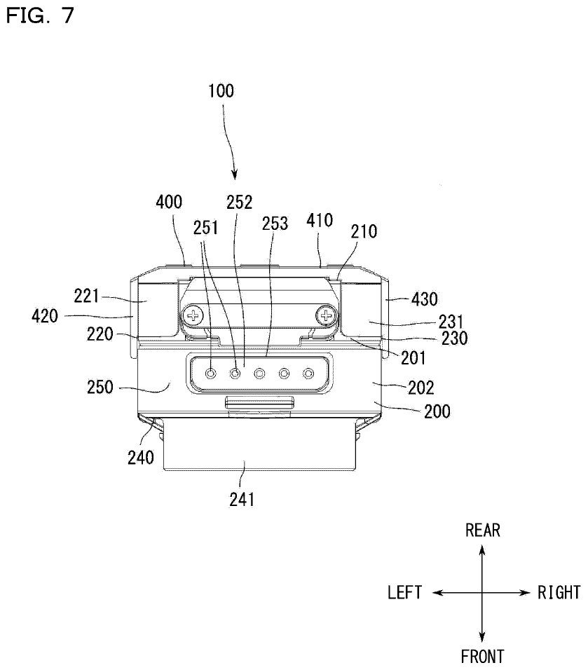

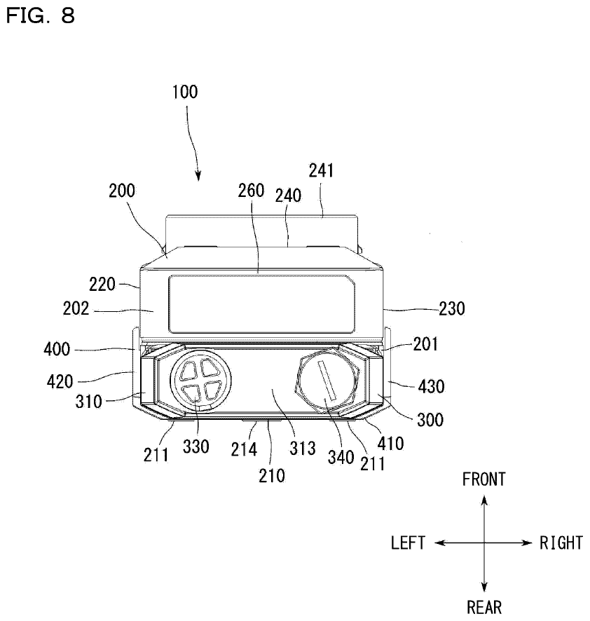

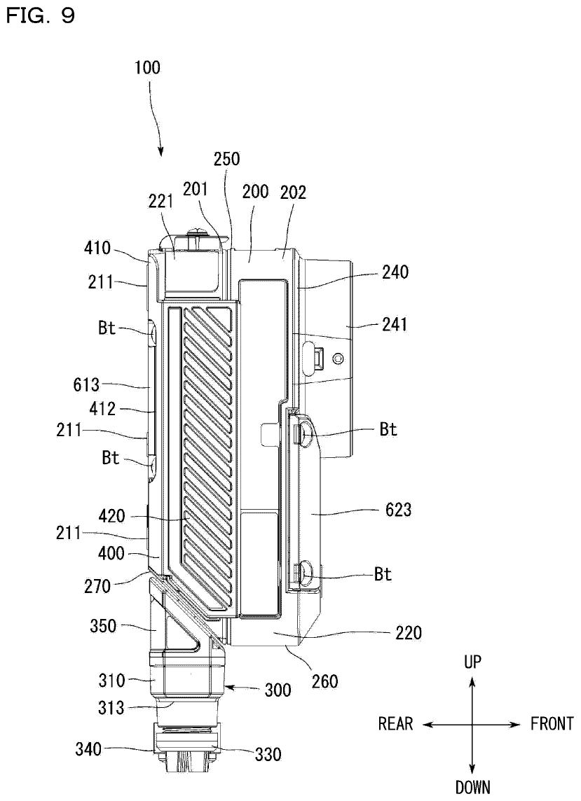

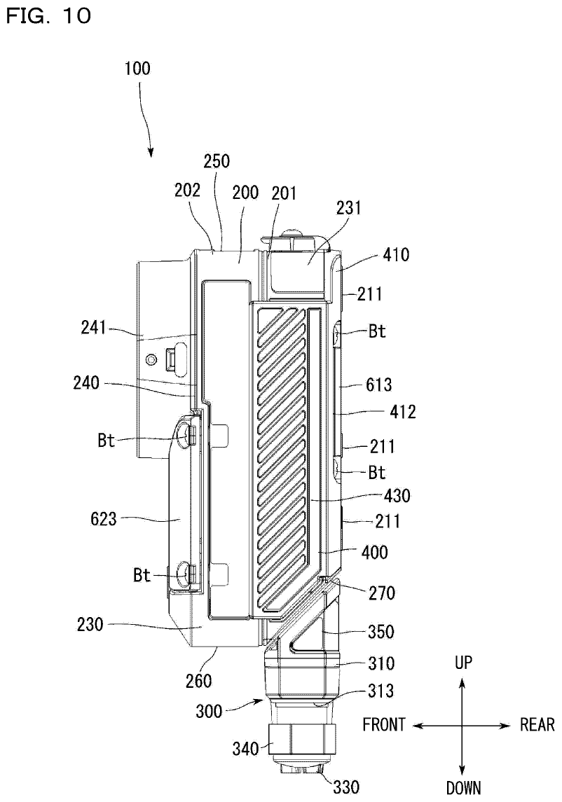

Hereinafter, details of the image sensor 100 will be described with reference to the drawings. FIG. 3 is a perspective view of the image sensor 100 as viewed from the upper rear side. FIG. 4 is a perspective view of the image sensor 100 as viewed from the upper front side. FIG. 5 is a front view of the image sensor 100. FIG. 6 is a rear view of the image sensor 100. FIG. 7 is a top view of the image sensor 100. FIG. 8 is a bottom view of the image sensor 100. FIG. 9 is a left side view of the image sensor 100. FIG. 10 is a right side view of the image sensor 100.

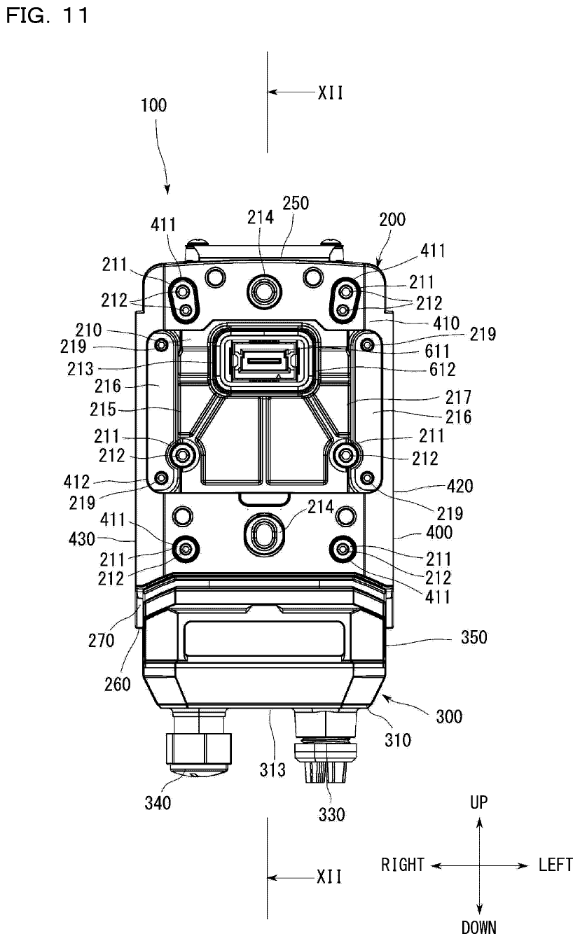

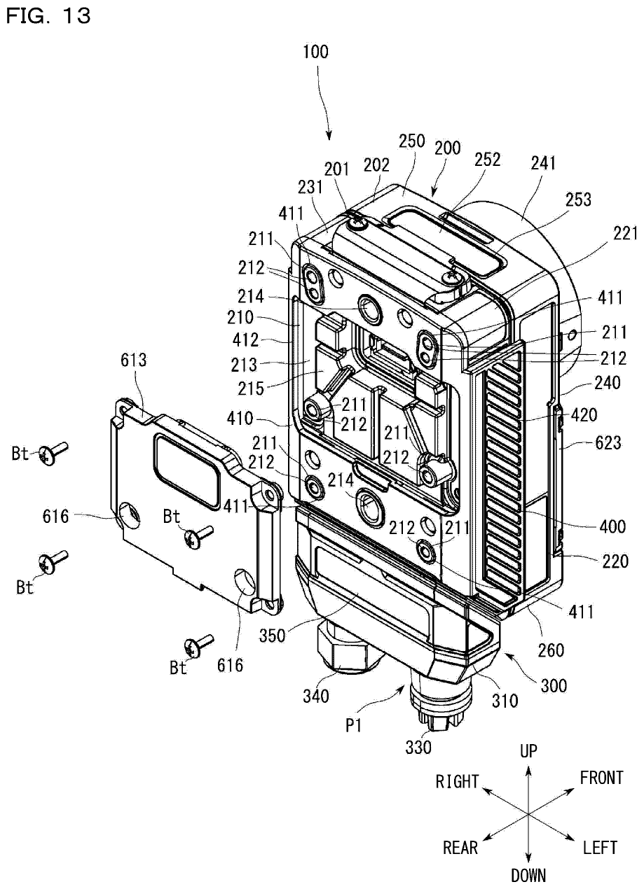

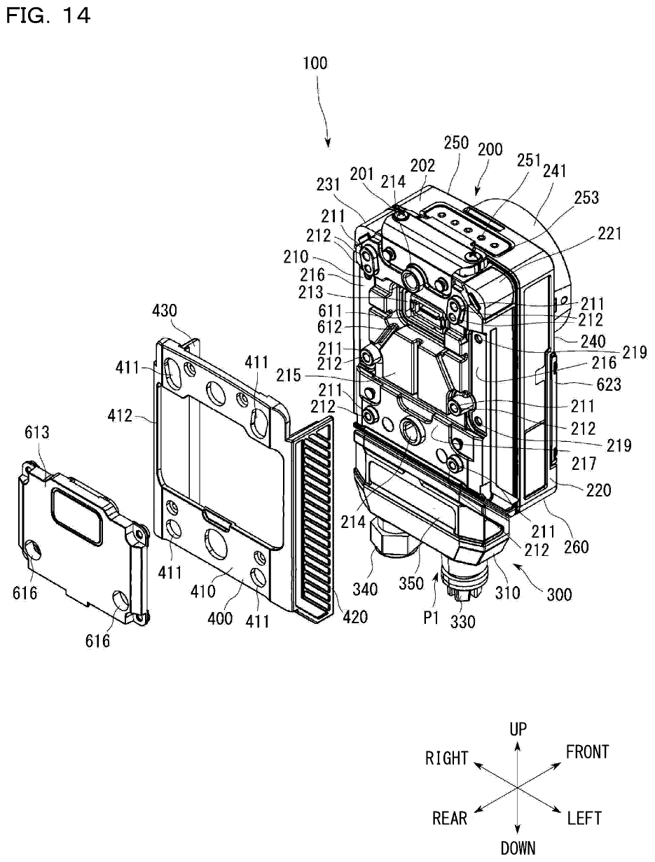

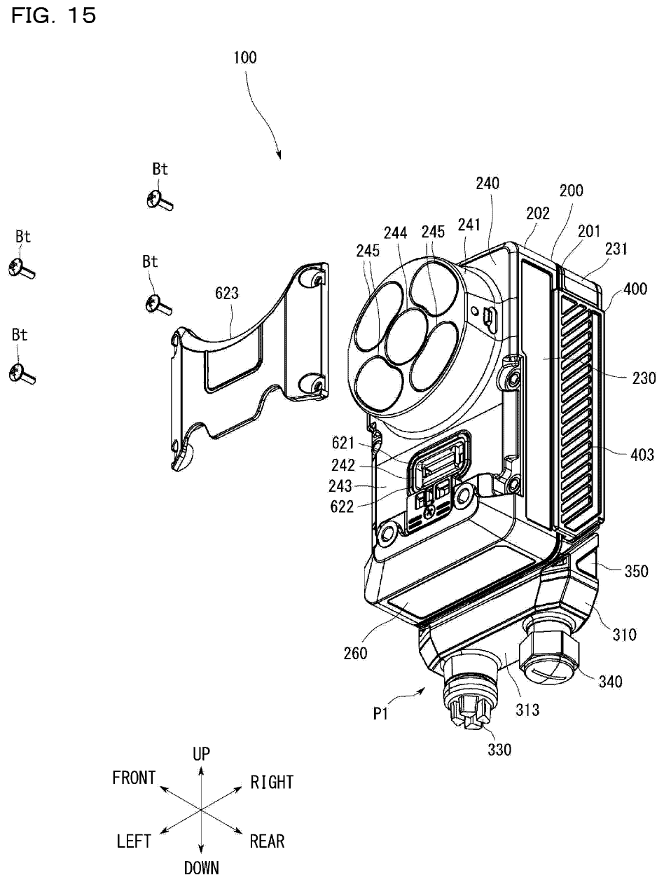

FIG. 11 is a rear view of image sensor 100. FIG. 12 is a cross-sectional view taken along line VI-VI of the image sensor 100 illustrated in FIG. 11. FIG. 13 is a perspective view of the image sensor 100 in a state in which a rear sensor connector lid 613 provided on a rear surface of the image sensor is opened as viewed from the upper rear side. FIG. 14 is a perspective view of the image sensor 100 in a state in which a cover member 400 and the rear sensor connector lid 613 are separated as viewed from the upper rear side. FIG. 15 is a perspective view of the image sensor 100 in a state in which a front sensor connector lid 623 is opened as viewed from the lower front side.

In the following description, front-rear, up-down, and left-right directions of the image sensor 100 are defined with reference to a state in which the image sensor 100 is viewed from the front side as illustrated in FIG. 3. In addition, the rear view illustrated in FIG. 11 illustrates a state in which the rear sensor connector lid 613 is detached, and the cross-sectional view of FIG. 12 illustrates a state in which the rear sensor connector lid 613 is attached. As illustrated in FIGS. 3 to 12 and the like, the image sensor 100 includes an image sensor housing 200 and the cover member 400.

### Image Sensor Housing 200

The image sensor housing 200 is made of metal such as aluminum, an aluminum alloy, brass, or stainless steel. A material forming the image sensor housing 200 is not limited to these metal materials. As the material forming the image sensor housing 200, a wide range of materials having a high thermal conductivity and capable of obtaining rigidity that can suppress deformation such as deflection or distortion of the image sensor housing 200 can be adopted. In addition, the external connection portion 300 is disposed below the image sensor housing 200. Note that it can also be said that the external connection portion 300 is a part of the image sensor housing 200.

As illustrated in FIGS. 3 to 12 and the like, the image sensor housing 200 includes a rear surface portion 210 (see FIG. 6) forming a rear surface of the image sensor housing 200, a left side surface portion 220 (see FIG. 9) forming a left side surface of the image sensor housing 200, a right side surface portion 230 (see FIG. 10) forming a right side surface of the image sensor housing 200, a front surface portion 240 (see FIG. 5) forming a front surface of the image sensor housing 200, an upper surface portion 250 (see FIG. 7) forming an upper surface of the image sensor housing 200, a lower surface portion 260 (see FIG. 8) forming a lower surface of the image sensor housing 200, and an inclined surface portion 270.

The image sensor housing 200 is a box body including an internal space IS surrounded by the above-described portions. Note that the front surface of the image sensor housing 200 is a surface on which an imaging hole 244 (to be described later) is provided. In addition, the lower surface of the image sensor housing 200 is a surface on a side on which the external connection portion 300 (to be described later) is provided.

The imaging unit 1 and the control unit 2 are disposed in the internal space IS of the image sensor housing 200. That is, the image sensor 100 is an integrated image sensor incorporating the imaging unit 1 and the control unit 2. As illustrated in FIG. 12 and the like, a main substrate 280 and a sub-substrate 290 are disposed in the internal space IS of the image sensor housing 200. In the internal space IS, the main substrate 280 is disposed on the rear side, and the sub-substrate 290 is disposed on the front side of the main substrate 280 alongside the main substrate 280.

As illustrated in FIGS. 3, 4, 12, and the like, the image sensor housing 200 is configured by combining a rear frame 201 and a front frame 202. The left side surface portion 220, the right side surface portion 230, and the upper surface portion 250 can be divided into front and rear parts. The rear parts of the left side surface portion 220, the right side surface portion 230, and the upper surface portion 250, and the inclined surface portion 270 are provided in the rear frame 201. The front parts of the left side surface portion 220, the right side surface portion 230, and the upper surface portion 250, and the lower surface portions 260 are provided in the front frame 202.

That is, the rear frame 201 has a bottomed tubular shape including the rear surface portion 210, the inclined surface portion 270, and the rear parts of the left side surface portion 220, the right side surface portion 230, and the upper surface portion 250. The front frame 202 has a bottomed tubular shape including the front surface portion 240, the lower surface portion 260, and the rear parts of the left side surface portion 220, the right side surface portion 230, and the upper surface portion 250. With such a configuration, the rigidity of each of the rear frame 201 and the front frame 202 can be enhanced. The image sensor housing 200 is configured by combining the rear frame 201 and the front frame 202 in the front-rear direction such that openings thereof overlap each other.

### Rear Surface Portion 210

A detailed configuration of the image sensor housing 200 will be described. In the image sensor housing 200, the rear surface portion 210 has a rectangular shape whose longitudinal direction is the up-down direction as viewed from the rear surface side. The inclined surface portion 270 is adjacent to a lower end of the rear surface portion 210. Note that the rear surface portion 210 and the inclined surface portion 270 are integrally formed. The rear surface portion 210 includes a sensor contact portion 211. The sensor contact portion 211 is a protrusion protruding from an outer surface 217 (surface on the rear surface side) of the rear surface portion 210. As illustrated in FIG. 11 and the like, the rear surface portion 210 includes six sensor contact portions 211. Three of the six sensor contact portions 211 are provided on each of the left and right sides. Then, a screw hole 212 extending in the front-rear direction is formed in the sensor contact portion 211. As illustrated in FIG. 12, the sensor contact portion 211 of the rear surface portion 210 of the image sensor 100 is fixed in contact with a prop Pr which is a frame of the conveyance unit A or the like. More specifically, the image sensor 100 is fixed to the prop Pr by making a screw penetrate an attachment hole of the prop Pr and screwing a portion of the screw protruding from the attachment hole into the screw hole 212 of the sensor contact portion 211 of the rear surface portion 210.

As illustrated in FIG. 11, two screw holes 212 are provided in each of the sensor contact portions 211 provided in the upper part of the six sensor contact portions 211. For example, an interval (pitch) of the attachment holes provided in the prop Pr may be different in a case where a device in which the image sensor 100 is disposed is different, in a case where an attachment position is different, and the like. The same image sensor 100 can be fixed to the prop Pr provided with attachment holes at a different pitch by using one of the screw holes 212 of each of the sensor contact portions 211 provided in the upper part.

For example, there is a case where screws are fastened to either one of the screw holes 212 of the sensor contact portions 211 in the upper part and the screw holes 212 of the sensor contact portions 211 at the center or the sensor contact portions 211 in the lower part. In this case, the common image sensor 100 can be attached to four types of the props Pr having different attachment hole pitches. Further, screws can be fastened to the screw holes 212 of the sensor contact portions 211 at the center and the screw holes 212 of the sensor contact portions 211 in the lower part. As a result, the common image sensor 100 can also be attached to the other props Pr provided with attachment holes at further different pitches.

That is, the image sensor 100 illustrated in the present embodiment can be attached to seven types of the props Pr having different attachment hole pitches. Note that the sensor contact portions 211 at the center and the lower part may include a plurality of the screw holes 212. In this case, the image sensor 100 can be attached to the props Pr having still other attachment hole pitches.

Heat of each portion of the image sensor housing 200 is conducted to the rear surface portion 210. Although details will be described later, heat generated by driving of the IC 500 attached to the main substrate 280 disposed in the internal space IS is also conducted to the rear surface portion 210 via a first thermally conductive member 501 and a second thermally conductive member 502.

The image sensor housing 200 is attached to the prop Pr by bringing the sensor contact portions 211 into contact with the prop Pr. As a result, the heat conducted to the image sensor housing 200 is conducted to the prop Pr via the sensor contact portions 211. Since the sensor contact portions 211 are in direct contact with the prop Pr, the heat can be efficiently conducted to the prop Pr.

The rear surface portion 210 of the image sensor housing 200 includes a rear sensor connector hole 213, a positioning portion 214, and a lid attachment portion 215. The rear sensor connector hole 213 is a hole penetrating in the front-rear direction, and is formed at a position overlapping a rear sensor connector 611 (to be described later) attached to the main substrate 280, in the front-rear direction. The rear sensor connector 611 is connected to the communication section 22.

The image sensor 100 according to the present embodiment can be connected to an external unit disposed on the rear surface portion 210 or the front surface portion 240. Note that the external unit connected to the rear surface portion 210 is, for example, a communication unit 700 (to be described later). The external unit connected to the front surface portion 240 is, for example, an illumination unit. Note that the external unit connected to the image sensor 100 is not limited to the communication unit 700 and the illumination unit. Here, a configuration in which the communication unit 700 to be attached to the rear surface portion 210 is attached as the external unit will be described as an example.

The rear sensor connector 611 is electrically connected to a communication unit connector 721 (to be described later) provided in the communication unit 700. The communication unit connector 721 is connected to a communication unit controller 720 provided in the communication unit 700, and the image sensor controller 21 of the image sensor 100 and the communication unit controller 720 of the communication unit 700 can communicate with each other by connecting the rear sensor connector 611 and the communication unit connector 721. Note that the rear sensor connector 611 may be configured to be capable of simultaneously transmitting a plurality of signals having different bands. The rear sensor connector 611 is also connected to the power source 23, and the rear sensor connector 611 is configured to be capable of supplying power from the power source 23 to the communication unit 700.

The positioning portion 214 has a recessed shape opened in the rear surface portion 210. A positioning protrusion 713 (to be described later) provided in the communication unit 700 is inserted into the positioning portion 214. Two positioning portions 214 are provided in the rear surface portion 210 of the image sensor housing 200. The positioning protrusion 713 is inserted into each of the two positioning portions 214. As a result, the communication unit 700 is positioned with respect to the rear surface portion 210. Note that the number of the positioning portions 214 only needs to be plural and is not limited to two. In addition, the shape of the positioning portion 214 may be a shape in which the communication unit 700 does not rotate with respect to the rear surface portion 210, such as an elliptical shape or a polygonal shape. In this case, the number of the positioning portions 214 may be one.

When the communication unit 700 is attached to the rear surface portion 210, the communication unit connector 721 penetrates the rear sensor connector hole 213 and is electrically connected to the rear sensor connector 611. The rear sensor connector hole 213 has a rectangular shape as viewed from the rear surface. Therefore, when the communication unit connector 721 penetrates the rear sensor connector hole 213, interference with the rear surface portion 210 of the communication unit connector 721 is suppressed.

As illustrated in FIG. 12 and the like, a rear sensor connector sealing member 612 is attached to a peripheral portion of the rear sensor connector hole 213. The rear sensor connector sealing member 612 is, for example, an elastically deformable member, such as silicone rubber or rubber, that can suppress entry of water, dust, dirt, and the like. In the image sensor 100, the rear sensor connector sealing member 612 has a rectangular annular shape overlapping the shape of the rear sensor connector hole 213, and a recessed groove recessed inward is formed to be continuous in the circumferential direction on an outer peripheral side. The rear sensor connector sealing member 612 is attached to the rear surface portion 210 by inserting the peripheral portion of the rear sensor connector hole 213 into the recessed groove of the rear sensor connector sealing member 612.

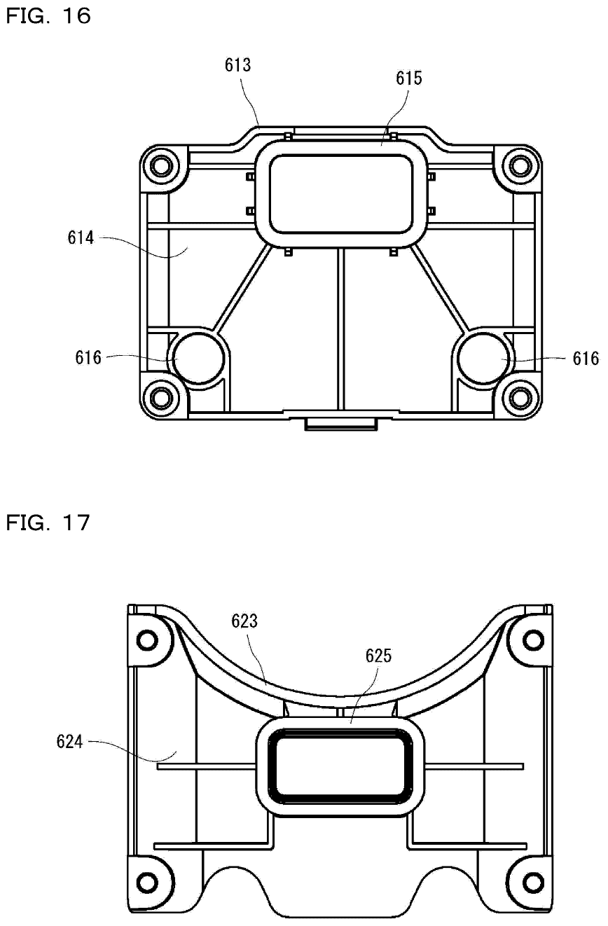

The rear sensor connector lid 613 is detachably attached to the rear surface portion 210. The rear sensor connector lid 613 can close the rear sensor connector hole 213. FIG. 16 is a view of the rear sensor connector lid 613 as viewed from an inner surface side. The rear sensor connector lid 613 is fitted into the lid attachment portion 215 provided on the outer surface 217 of the rear surface portion 210. The rear sensor connector lid 613 in a state of being attached to the lid attachment portion 215 is fixed to the rear surface portion 210 with a screw Bt. In the rear surface portion 210, the sensor contact portions 211 are also provided in the lid attachment portion 215.

In this case, the rear sensor connector lid 613 is provided with contact portion through-holes 616. The sensor contact portions 211 penetrate the contact portion through-holes 616. As a result, the sensor contact portions 211 provided in the lid attachment portion 215 can be exposed to the outside in a state in which the rear sensor connector lid 613 is fixed to the rear surface portion 210. Therefore, the image sensor 100 can be brought into contact with the prop Pr when being fixed to the prop Pr in a state in which the rear sensor connector lid 613 is attached to the lid attachment portion 215. In addition, the screw hole 212 is formed in the sensor contact portion 211, and thus can be used for screwing when the image sensor housing 0200 is fixed to the prop Pr.

As illustrated in FIGS. 12, 16, and the like, in the state in which the rear sensor connector lid 613 is attached to the lid attachment portion 215, a pressing portion 615 is provided on an inner surface 614 opposing the rear surface portion 210. The pressing portion 615 has a shape overlapping the rear sensor connector sealing member 612 in a plan view. After the rear sensor connector lid 613 is attached to the lid attachment portion 215 of the rear surface portion 210, the pressing portion 615 presses the rear sensor connector sealing member 612 by being pressed against the rear surface portion 210 by the screw Bt. As a result, the rear sensor connector sealing member 612 is elastically deformed. Then, the rear sensor connector sealing member 612 is in close contact with the pressing portion 615 and the peripheral portion of the rear sensor connector hole 213 of the rear surface portion 210. As a result, entry of foreign matter such as water, dust, and dirt from the rear sensor connector hole 213 is suppressed.

Note that the rear sensor connector lid 613 may be made of a material having a thermal conductivity lower than that of metal forming the image sensor housing 200, such as a silicon resin, an epoxy resin, or an ABS resin. In this case, the material may be the same as or different from the material of the cover member 400 described above. In addition, the rear sensor connector lid 613 may be made of the same metal material as that of the image sensor housing 200.

### Left Side Surface Portion 220 and Right Side Surface Portion 230

The left side surface portion 220 and the right side surface portion 230 are surfaces adjacent to the front surface portion 240, and are disposed so as not to be adjacent to each other. That is, the left side surface portion 220 and the right side surface portion 230 are formed to be continuous with each of a pair of long sides of the rectangular front surface portion 240. Lower ends of the left side surface portion 220 and the right side surface portion 230 are inclined upward as proceeding to the rear side. Such inclined portions are portions adjacent to the inclined surface portion 270. The left side surface portion 220 forms the left side surface of the image sensor housing 200, and the right side surface portion 230 forms the right side surface of the image sensor housing 200. Therefore, due to the positional relationship of the left side surface portion 220 and the right side surface portion 230 with respect to the front surface portion 240 forming the front surface of the image sensor housing 200, the right side surface and the left side surface of the image sensor housing 200 are paired surfaces that intersect the front surface of the image sensor housing 200 and face in mutually different directions.

As illustrated in FIGS. 2, 3, 4, 7, 9, and the like, a left lamp 221 is provided at a corner where an upper end of the left side surface portion 220 intersects a left end of the upper surface portion 250. In addition, as illustrated in FIGS. 2, 3, 4, 7, 10, and the like, a right lamp 231 is provided at a corner where an upper end of the right side surface portion 230 intersects a right end of the upper surface portion 250.

As illustrated in FIG. 2, the left lamp 221 and the right lamp 231 are connected to the image sensor controller 21. Then, the left lamp 221 and the right lamp 231 controlled to be turned on by the image sensor controller 21.

Examples of the left lamp 221 and the right lamp 231 may include a configuration using a light emitting element such as an LED or an organic EL. Note that the left lamp 221 and the right lamp 231 are not limited to these elements.

For example, the left lamp 221 and the right lamp 231 have a configuration capable of emitting green light that is light of a first color and emitting red light that is light of a second color different from the first color. Then, the image sensor controller 21 controls the left lamp 221 and the right lamp 231 to emit the light of the first color when the image sensor 100 is in an operable state, for example, when the imaging unit I can perform imaging, communication, or the like. In addition, the image sensor controller 21 controls the left lamp 221 and the right lamp 231 to emit the light of the second color during the operation, such as imaging, image processing, or communication, of the image sensor 100.

As the image sensor controller 21 controls the light emission of each of the left lamp 221 and the right lamp 231, it is possible to notify the outside of a state of the image sensor 100, such as the operable state or the state during the operation.

Note that the left lamp 221 and the right lamp 231 are configured to emit light of the same color in the present embodiment, but may emit beams of light of different colors without being limited thereto. In addition, the image sensor controller 21 may be configured to be capable of controlling not only turning on and off but also blinking of the left lamp 221 and the right lamp 231. In addition, the image sensor controller 21 may control the light emission of each of the left lamp 221 and the right lamp 231 also in a case where communication is performed by the communication unit 700 in a state in which the communication unit 700 (to be described later) is connected to the image sensor 100. Note that the above-described light emission operation of each of the left lamp 221 and the right lamp 231 is an example, and is not limited to this operation.

### Front Surface Portion 240

The front surface portion 240 has a shape substantially coinciding with the rear surface portion 210 and the inclined surface portion 270, that is, a rectangular shape whose longitudinal direction is the up-down direction as viewed from the rear surface. The front surface portion 240 and the rear surface portion 210 are surface portions on opposite sides of the image sensor housing 200. The front surface portion 240 includes a front protrusion 241 protruding from an upper part to the front side. The front protrusion 241 has a cylindrical shape having a bottom surface on the front side.

The imaging hole 244 and four light source holes 245 are provided in the front of the front protrusion 241. The imaging hole 244 is a through-hole. In the internal space IS, the lens section 11f is disposed on the rear side of the imaging hole 244. The sub-substrate 290 includes a through-hole. The through-hole of the sub-substrate 290 overlaps the CMOS sensor 11c in the front-rear direction as viewed from the front side. The lens section 11f is disposed to penetrate the through-hole of the sub-substrate 290. Then, an image of the workpiece W (reflection light reflected on the surface of the workpiece W) enters the lens section 11f disposed in the internal space IS of the image sensor housing 200 through the imaging hole 244. The image of the workpiece W entering from the imaging hole 244 is optically modulated while passing through the lens section 11f, and is incident on the CMOS sensor 11c in a focused state.

For example, a plate-shaped transparent cover made of a material that transmits light, such as glass, is attached to the imaging hole 244. The transparent cover is attached to suppress entry of foreign matter such as dirt, dust, and moisture. Note that the transparent cover and the image sensor housing 200 are preferably sealed and fixed with a sealing material such as an adhesive or a seal, for example. In addition, the sealing material may be omitted in a case where it is difficult for foreign matter to enter. In addition, as the sealing material, for example, an optical element such as an optical filter capable of blocking light of a specific wavelength or phase may be used. In addition, the sealing material provided in the imaging hole 244 may be an optical element having an optical function equivalent to that of a convex lens or a concave lens.

The four light source holes 245 are through-holes independent from one another. The LED 10a of the illumination module 10 is disposed on the rear side of the light source holes 245 in the internal space IS. Illumination light emitted from the LED 10a passes through the light source holes 245 and is emitted to the workpiece W. Similarly to the imaging hole 244, a translucent sealing material is disposed in each of the light source holes 245. Note that the sealing material used for the light source holes 245 may be an optical element having a characteristic similar to that used for the imaging hole 244. In addition, an optical element having a characteristic of focusing light on the workpiece W may be used.

Since the illumination light is emitted through the four light source holes 245 in the image sensor 100, it is possible to suppress formation of a shadow on at least a surface of the workpiece W to be captured. Note that the number of the light source holes 245 is not limited to four as long as it is possible to suppress the shadow from being formed on the surface of the workpiece W to be captured.

In the image sensor 100, the external unit can also be connected to the front surface portion 240 in addition to the rear surface portion 210. Then, a front sensor connector 621 having a configuration similar to that of the rear sensor connector 611 is disposed on the sub-substrate 290. The front sensor connector 621 is electrically connected to a wiring pattern provided on the sub-substrate 290 to constitute an electric circuit. A front sensor connector hole 242 penetrating in the front-rear direction is formed at a position, which overlaps the front sensor connector 621 (to be described later) in the front-rear direction, in a lower part of the front protrusion 241 of the front surface portion 240. The front sensor connector hole 242 has a configuration similar to that of the rear sensor connector hole 213. A front sensor connector sealing member 622 having a configuration similar to that of the rear sensor connector sealing member 612 is attached also to the front sensor connector hole 242.

FIG. 17 is a view of the front sensor connector lid 623 as viewed from an inner surface side. The front sensor connector lid 623 covering the front sensor connector hole 242 is detachably attached to the front surface portion 240. A basic configuration of the front sensor connector lid 623 is the same as that of the rear sensor connector lid 613. Therefore, a pressing portion 625 that presses the front sensor connector sealing member 622 is provided on an inner surface 624 of the front sensor connector lid 623. The front surface portion 240 is provided with a lid attachment portion 243. As the front sensor connector lid 623 is fixed to the lid attachment portion 243 by the screw Bt, the pressing portion 625 deforms the front sensor connector sealing member 622. As a result, it is possible to suppress foreign matter such as water, dirt, and dust from entering the internal space IS of the image sensor housing 200.

### Upper Surface Portion 250 and Lower Surface Portion 260

The upper surface portion 250 and the lower surface portion 260 form the upper surface and the lower surface of the image sensor housing 200. The area of the lower surface portion 260 is smaller than that of the upper surface portion 250. The lower surface portion 260 is adjacent to the left side surface portion 220, the right side surface portion 230, the front surface portion 240, and the inclined surface portion 270.

As illustrated in FIG. 7, the upper surface portion 250 of the image sensor 100 is provided with top lamps 251 at the central portion in the left-right direction. The upper surface portion 250 includes a recess 253 covered with a translucent cover 252, and the top lamps 251 arc disposed in the recess 253 covered with the cover 252. For example, the top lamps 251 emit red light when power is supplied to the image sensor 100 and the image sensor 100 is in an off-state, that is, when the image sensor 100 is in a standby state, and emits green light when the image sensor 100 is in an on-state. The above-described light emission operation of the top lamps 251 described above is an example, and is not limited to this operation.

### Inclined Surface Portion 270

The inclined surface portion 270 has an inclination in which lower sides of the lower end of the rear surface portion 210 and the inclined surface portion 270 are disposed on the front side. Note that it can also be said that the inclined surface portion 270 is configured to bend the lower end of the rear surface portion 210 by 45 degrees. The external connection portion 300 is disposed to oppose an outer surface of the inclined surface portion 270.

### Main Substrate 280 and Sub-Substrate 290

As illustrated in FIG. 11 and the like, in the internal space IS, the main substrate 280 is disposed such that one surface thereof opposes an inner surface 218 of the rear surface portion 210. The IC 500, the rear sensor connector 611, and the CMOS sensor 11c are disposed on the main substrate 280. Note that the IC 500 and the rear sensor connector 611 are disposed on a surface of the main substrate 280 on the rear side, that is, on the surface opposing the inner surface 218 of the rear surface portion 210. The CMOS sensor 11c is disposed on a surface of the main substrate 280 on the front side. Each of the rear sensor connector 611 and the CMOS sensor 11c is connected to the IC 500, that is, the image sensor controller 21 via a wiring pattern provided on the main substrate 280. The rear sensor connector 611 is connected to the power source 23 via the wiring pattern.

The IC 500 is a processor that performs image processing, control of each portion, and the like. Therefore, when the image sensor 100 operates, the IC 500 generates heat due to power supply. In recent years, the amount of computation has increased due to an increase in resolution of image data in the image sensor 100. Therefore, there is an increasing demand for speeding up arithmetic processing for the IC 500. Therefore, an inference accelerator is used as the accelerator 21c of the image sensor controller 21 included in the IC 500. Due to the use of the inference accelerator, the amount of heat generation increases as compared with a conventional computing element.

In the image sensor 100 according to the present embodiment, the heat of the IC 500 is conducted to the image sensor housing 200 and released to the outside of the image sensor housing 200, whereby a temperature rise of the internal space IS can be suppressed. In order to efficiently conduct the heat of the IC 500 to the image sensor housing 200, the first thermally conductive member 501 and the second thermally conductive member 502 are used. The first thermally conductive member 501 is disposed so as to be in surface contact with the IC 500 disposed on the main substrate 280.

The first thermally conductive member 501 is made of, for example, a material in which a filler such as carbon fiber, magnesium oxide, magnesium hydroxide, anhydrous magnesium carbonate, aluminum oxide, aluminum nitride, silica, or boron nitride is mixed in a resin material such as a silicon resin, a polyamide resin, a polycarbonate resin, a polyester resin, an acrylic resin, or a rubber. Note that a member that enhances thermal conduction, such as heat transfer grease, may be interposed between the first thermally conductive member 501 and the IC 500.

The first thermally conductive member 501 has a high thermal conductivity, but may have an electrical conductivity due to the influence of the filler. Therefore, in the image sensor 100 according to the present embodiment, the second thermally conductive member 502 having an insulating property is disposed between the first thermally conductive member 501 and the image sensor housing 200. In this manner, the heat generated by the IC 500 is sequentially conducted in the first thermally conductive member 501 and the second thermally conductive member 502, and is conducted to the image sensor housing 200.

At this time, an insulation state between the image sensor housing 200 and the IC 500 is also maintained by the second thermally conductive member 502. Note that a thermal conductivity of the second thermally conductive member 502 is lower than that of the first thermally conductive member 501. Therefore, a thickness of the second thermally conductive member 502 is formed to be thinner than that of the first thermally conductive member 501. Further, it suffices that the thickness of the second thermally conductive member 502 is a thickness that can reliably insulate the image sensor housing 200 from the IC 500.

Each of the first thermally conductive member 501 and the second thermally conductive member 502 is made of an elastically deformable resin. The first thermally conductive member 501 and the second thermally conductive member 502 in a state of being elastically deformed are disposed between the image sensor housing 200 and the IC 500. As a result, the first thermally conductive member 501 and the second thermally conductive member 502 are brought into close contact with each other due to restoring forces. Similarly, the first thermally conductive member 501 and the second thermally conductive member 502 are in close contact with the IC 500 and the image sensor housing 200, respectively. As a result, the heat of the IC 500 can be efficiently conducted to the image sensor housing 200. As a result, it is possible to suppress the temperature rise of the internal space IS of the image sensor housing 200.

Note that the first thermally conductive member 501 and the second thermally conductive member 502 may be disposed in a state of not being elastically deformed. Even in this case, the first thermally conductive member 501 and the second thermally conductive member 502 expand due to the heat from the IC 500 and the heat in the internal space IS of the image sensor housing 200. As a result, the first thermally conductive member 501 is pressed against the IC 500. In addition, the second thermally conductive member 502 is in close contact with the image sensor housing 200. Therefore, the heat of the IC 500 can be efficiently conducted to the image sensor housing 200.

The IC 500 is the heating element in the above description, but is not limited thereto. For example, there is a case where an element, such as the DSP 21a, the FPGA 21b, or the accelerator 21c of the image sensor controller 21 of the control unit 2, is configured using a chip different from the IC 500 and is a heating element. In such a case, heat of the element as the heating element may be conducted to the image sensor housing 200 using the first thermally conductive member 501 and the second thermally conductive member 502. In addition, also in a case in which the imaging unit 1 includes elements such as a DSP and an FPGA and these elements are heating elements, heat of these elements may be similarly conducted to the image sensor housing 200. Note that an element that can be a heating element is disposed so as to oppose the inner surface 218 of the rear surface portion 210 when the main substrate 280 is formed in the image sensor 100. Then, heat generated from the element that can be the heating clement is conducted to the rear surface portion 210 via the first thermally conductive member 501 and the second thermally conductive member 502.

### External Connection Portion 300

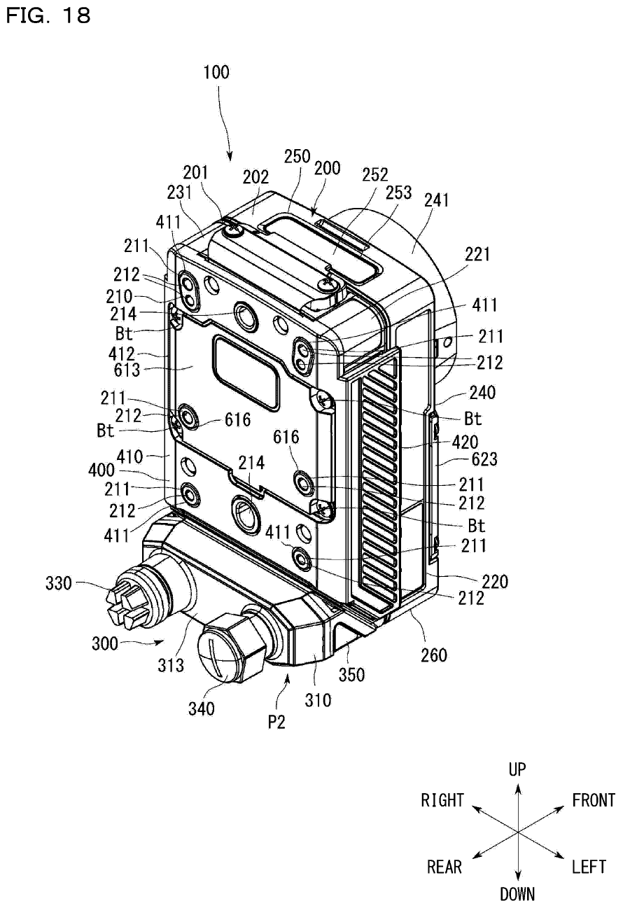

FIG. 18 is a perspective view of the image sensor 100 in a state in which the external connection portion 300 is moved to a second position P2 as viewed from the upper rear side. As illustrated in FIG. 12, the external connection portion 300 includes an external connection portion housing 310. The external connection portion housing 310 has a trapezoidal columnar shape in a side view. The external connection portion housing 310 is made of the same metal material as that of the image sensor housing 200, but may be made of a different material.

The external connection portion housing 310 includes an opposing surface portion 311 opposing the inclined surface portion 270. Then, the opposing surface portion 311 is coupled to the inclined surface portion 270 via a rotation shaft 312. The external connection portion 300 is rotatable about the rotation shaft 312.

The external connection portion housing 310 includes a connection surface portion 313 forming a surface not adjacent to the opposing surface portion 311. The external connection plugs 330 and 340 are attached to the connection surface portion 313. Each of the external connection plugs 330 and 340 includes a portion partially exposed to the outside and disposed inside the external connection portion housing 310. The portion disposed inside the external connection portion housing 310 is electrically connected to at least one of the main substrate 280 and the sub-substrate 290 via an inner wire (not illustrated).

In the image sensor 100, the communication cable Cn is connected to the external connection plug 330 and used for data communication. In addition, the power cable Cp is connected to the external connection plug 340 and used for power supply. Note that a heat insulator is disposed between the external connection plug 330 and the external connection plug 340, and the external connection portion housing 310, in other words, the image sensor housing 200. This suppresses the heat of the image sensor housing 200 from being conducted to the external connection plug 330 and the external connection plug 340. As a result, even if the temperature of the image sensor housing 200 rises due to an increase in power consumption of the image sensor 100, the general-purpose communication cable Cn and power cable Cp can be connected to the external connection plugs 330 and 340.

In the image sensor 100 of the present embodiment, the external connection plug 330 is used for communication, and the external connection plug 340 is used for power, but the invention is not limited thereto. For example, in a case where the image sensor controller 21, the communication section 22, and the power source 23 of the image sensor 100 are compatible with a network compliant with power supply such as PoE (Power on Ethernet), a cable used for both data communication and power supply may be connected to at least one of the external connection plugs 330 and 340.

Note that the number of external connection plugs of the image sensor 100 is not limited to two, and three or more external connection plugs may be provided. In a case where three or more external connection plugs are provided, one of the plurality of external connection plugs may be the external connection plug 340 for power supply, and the others may be the external connection plugs 330 for communication. At least one external connection plug may be used for both the data communication and the power supply.

The rotation shaft 312 has a cylindrical shape, and the inner wire penetrates an internal space thereof. The inner wire has an intermediate portion that is not fixed and has flexibility. Therefore, the connection state between the external connection plugs 330 and 340 and the main substrate 280 or the sub-substrate 290 is maintained even when the external connection portion 300 rotates.

In the image sensor 100, the external connection portion 300 is rotated about the rotation shaft 312 to turn to a first position P1 at which the external connection plugs 330 and 340 extend downward (see FIG. 3) and a second position P2 (see FIG. 18) at which the external connection plugs 330 and 340 extend rearward. In this manner, even when there is an obstacle below the image sensor 100, the external connection plugs 330 and 340 can be disposed at positions avoiding the obstacle by rotating the external connection portion 300. Therefore, the degree of freedom of wiring of cables connected to the external connection plugs 330 and 340 can be increased. In addition, connection positions of the cables can be changed by changing directions of the external connection plugs 330 and 340, and it is also possible to shorten the cables.

The external connection portion 300 includes an external connection portion cover 350. The external connection portion cover 350 covers a part of the external connection portion housing 310. The external connection portion cover 350 is made of, for example, a material having a thermal conductivity lower than that of metal forming the external connection portion housing 310, such as a silicon resin, an epoxy resin, or an ABS resin. As a result, it is difficult for the user's hand to directly touch the external connection portion 300, and a sensible temperature of the user can be suppressed to be low.

### Cover Member 400

As illustrated in FIG. 14, the cover member 400 is detachably attached to the image sensor housing 200. The cover member 400 includes a first cover portion 410, a second cover portion 420, and a third cover portion 430. The first cover portion 410 has a rectangular shape whose longitudinal direction is the up-down direction as viewed from the rear surface side. The second cover portion 420 and the third cover portion 430 are formed continuously with a portion forming a long side of the first cover portion 410. That is, in the cover member 400, the first cover portion 410, the second cover portion 420, and the third cover portion 430 are configured as a single member.

When the cover member 400 is attached to the image sensor housing 200, the first cover portion 410 covers a part of the rear surface portion 210. The second cover portion 420 covers a part of the left side surface portion 220, and the third cover portion 430 covers a part of the right side surface portion 230.

The cover member 400 is made of, for example, a material having a thermal conductivity lower than that of metal forming the image sensor housing 200, such as a silicon resin, an epoxy resin, or an ABS resin. The cover member 400 is made of a resin to be elastically deformable. When the cover member 400 is attached to the image sensor housing 200, an elastic force of the cover member 400 causes the second cover portion 420 and the third cover portion 430 to press the left side surface portion 220 and the right side surface portion 230, respectively. In the present embodiment, the cover member 400 is fixed to the image sensor housing 200 by the clastic force, but the invention is not limited thereto. For example, the cover member 400 may be fixed to the image sensor housing 200 by adopting a fixing method such as engagement using an engaging portion or screwing.

The first cover portion 410 includes a contact portion through-hole 411 and a lid through-hole 412. The contact portion through-hole 411 is provided at a position where the sensor contact portion 211 of the first cover portion 410 penetrates when the cover member 400 is attached to the image sensor housing 200. When the cover member 400 is attached to the image sensor housing 200, the sensor contact portion 211 penetrates the contact portion through-hole 411 and protrudes to the rear side of the first cover portion 410. As a result, the image sensor 100 can be attached to the prop Pr in a state in which the cover member 400 is attached to the image sensor housing 200, and the sensor contact portion 211 can be brought into contact with the prop Pr. That is, even when the image sensor 100 to which the cover member 400 is attached is attached to the prop Pr, the heat of the image sensor housing 200 is efficiently conducted to the prop Pr.

When the cover member 400 is attached to the image sensor housing 200, the rear sensor connector lid 613 penetrates the lid through-hole 412. That is, the rear sensor connector lid 613 can be attached to and detached from the lid attachment portion 215 of the rear surface portion 210 in the state in which the cover member 400 is attached to the image sensor housing 200.

The rear surface portion 210 of the image sensor housing 200 is fixed to the prop Pr such as a frame of a device including the conveyance unit A. As a result, the heat of the rear surface portion 210 is efficiently conducted to the prop Pr via the sensor contact portion 211. As a result, the temperature rise inside the image sensor 100 can be suppressed.

Further, as described above, image sensor 100 is sometimes PoE enabled. In a case where power is supplied via PoE, a higher voltage is supplied to the image sensor 100 as compared with a case where only power is supplied by the power cable Cp. That is, a high voltage is also applied to an element provided inside the image sensor 100 by PoE, and as a result, the amount of heat generation in the image sensor 100 also increases. In addition, the amount of heat generation of the IC 500 also increases in many cases. As described above, the sensor contact portion 211 of the image sensor housing 200 comes into contact with the prop Pr. As a result, the heat accumulated in the internal space IS of the image sensor housing 200 and the heat generated from the heating element such as the IC 500 can be efficiently conducted to the prop Pr, and the temperature rise inside the image sensor 100 can be suppressed.

The user sometimes grips the image sensor 100 during the operation or immediately after the operation stops. In a case where a member having a shape like the image sensor housing 200 is gripped, the user supports the rear surface portion 210 with the palm, supports one of the left side surface portion 220 and the right side surface portion 230 with the thumb, and supports the other of the left side surface portion 220 and the right side surface portion 230 with all or some of the remaining fingers.

At this time, the user's palm and fingers come into contact with the cover member 400. As a result, the sensible temperature of the user can be suppressed to be low. Since the sensible temperature of the user can be suppressed to be low, it is difficult for the user to erroneously recognize that there is an abnormality in the image sensor 100 due to a temperature rise. Therefore, the convenience of the user can be enhanced by using the image sensor 100 of the present embodiment.

When gripping the image sensor 100, the user often does not touch the imaging hole 244 and the light source hole 245 through which the image of the workpiece W is incident. That is, the front surface portion 240 of the image sensor housing 200 is hardly touched by the user. Therefore, the cover member 400 is configured not to cover the front surface portion 240. In this manner, the heat of the image sensor housing 200 is easily released from the front surface portion 240 to the outside, and the temperature rise of the image sensor 100 can be suppressed.

In the image sensor 100 of the present embodiment, the second cover portion 420 and the third cover portion 430 of the cover member 400 cover portions formed on the rear frame 201 of the left side surface portion 220 and the right side surface portion 230 of the image sensor housing 200. However, the invention is not limited to this configuration, and at least a part of portions formed on the front frame 202 of the left side surface portion 220 and the right side surface portion 230 may be covered. In addition, for example, a member made of a material having a lower thermal conductivity than that of a metal material forming the image sensor housing 200 such as a heat insulating sheet may be disposed in portions not covered with the cover member 400 of the left side surface portion 220 and the right side surface portion 230.

In addition, in a case where the image sensor 100 is lightweight, the user can grip the image sensor 100 only with the fingers. In this case, the palm of the user does not touch the image sensor 100. In addition, whether the image sensor 100 is lightweight or heavy differs depending on the user. Therefore, it suffices that the cover member 400 provided in the image sensor 100 includes at least the second cover portion 420 covering the left side surface portion 220 of the image sensor housing 200 and the third cover portion 430 covering the right side surface portion 230. However, in consideration of a case where the palm comes into contact, the cover member 400 preferably includes the first cover portion 410 that covers the rear surface portion 210. In addition, the second cover portion 420 and the third cover portion 430 are integrally formed by the first cover portion 410, and handling of the cover member 400 is facilitated. From this point of view, the cover member 400 preferably includes the first cover portion 410.

### Communication Unit 700

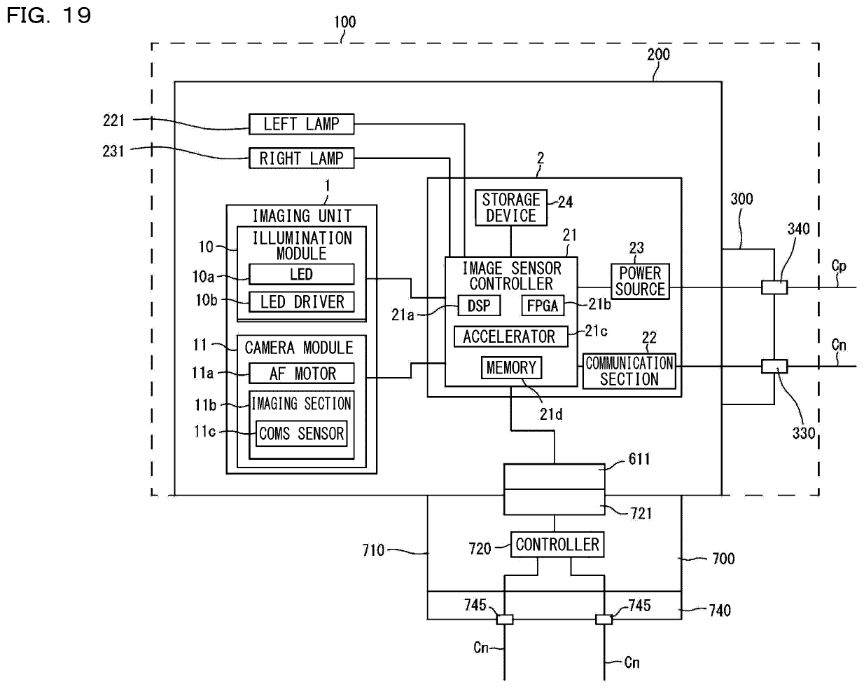

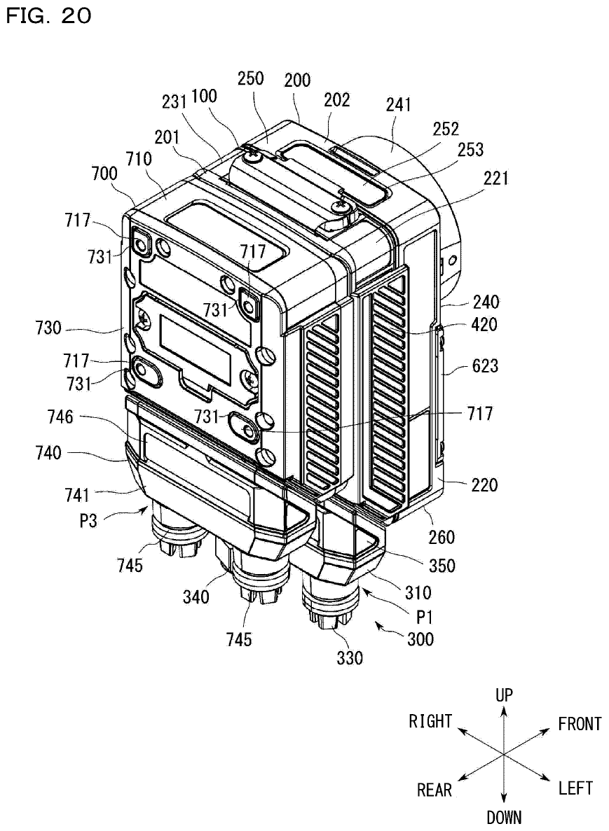

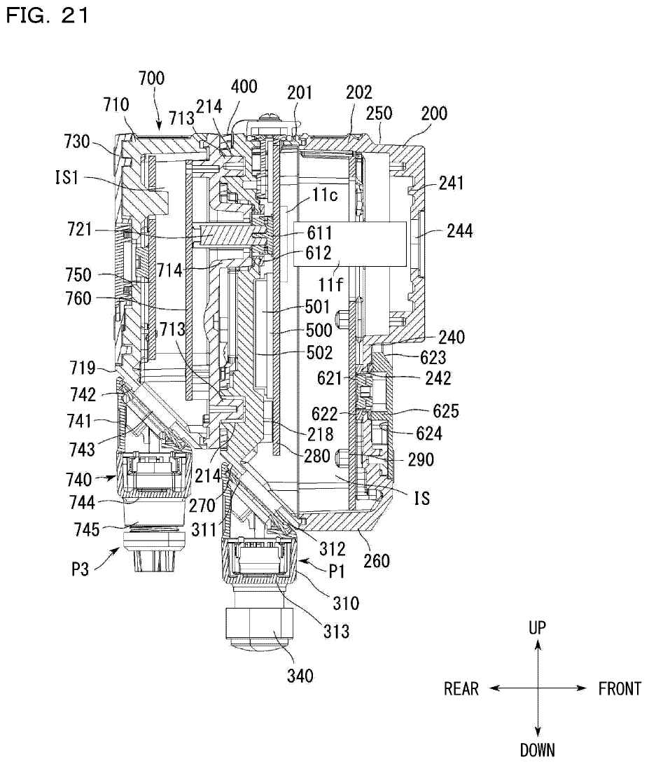

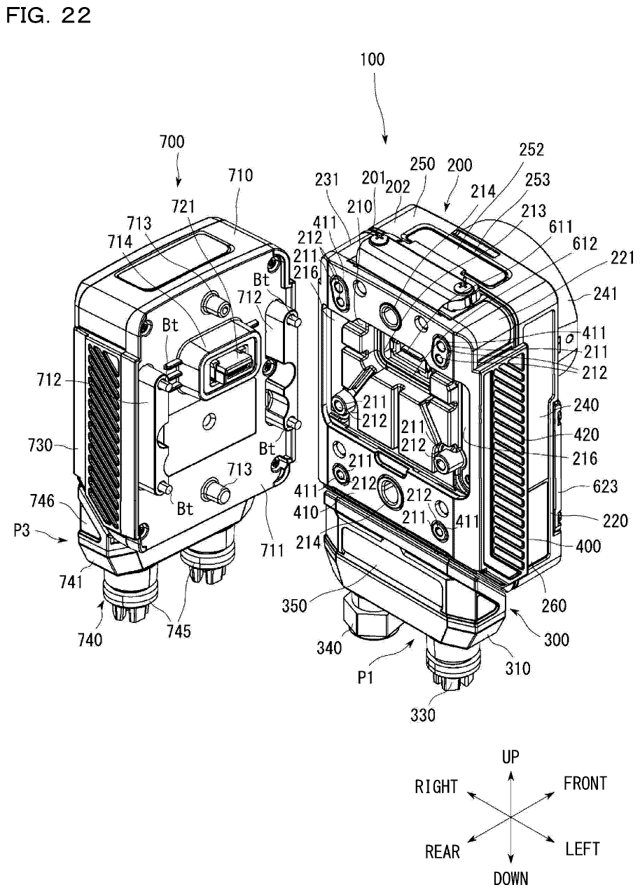

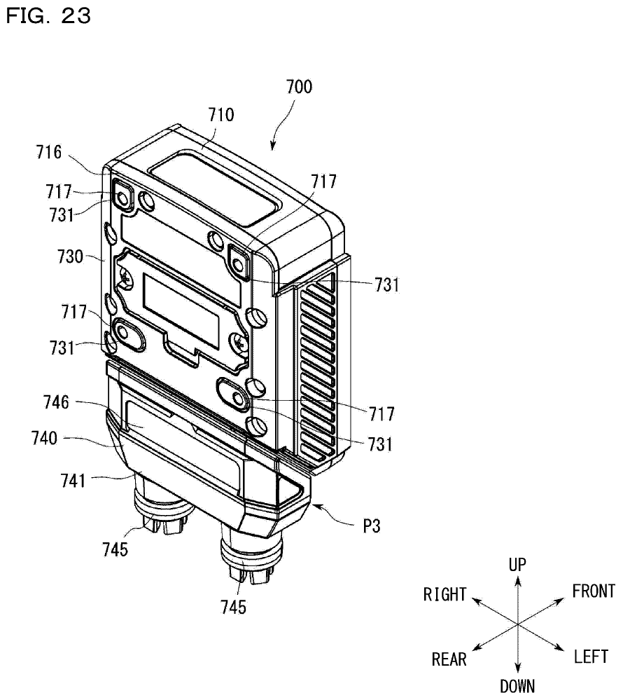

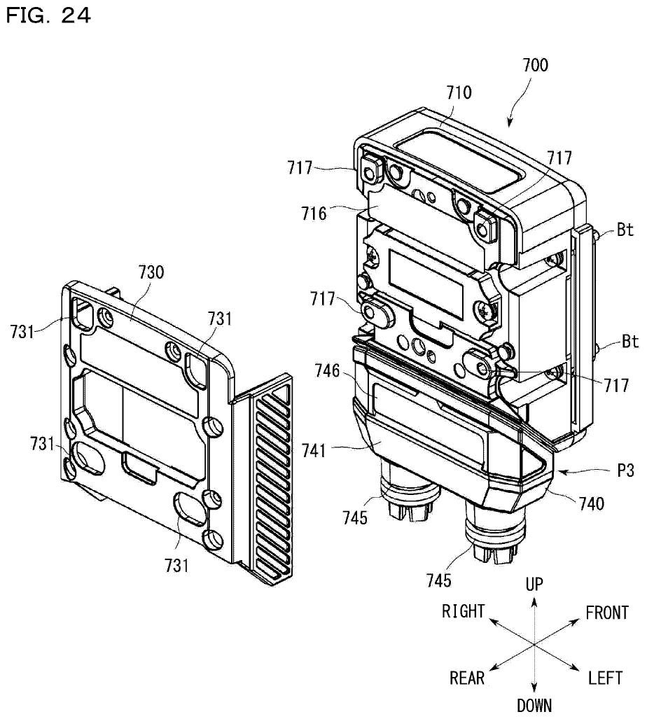

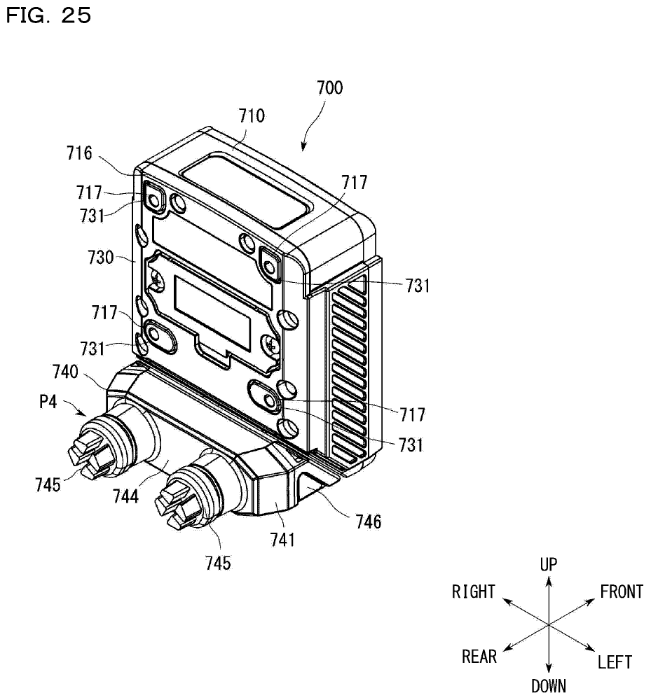

In addition, the communication unit 700 can be connected to the image sensor 100. FIG. 19 is a block diagram of the image sensor 100 to which the communication unit 700 is attached. FIG. 20 is a perspective view of the image sensor 100 to which the communication unit 700 is attached as viewed from the upper rear side. FIG. 21 is a cross-sectional view of the image sensor 100 in a state in which the communication unit 700 is attached. FIG. 22 is a perspective view illustrating a state in which the communication unit 700 is separated from the image sensor 100. FIG. 23 is a perspective view of the communication unit 700 as viewed from the upper rear side. FIG. 24 is a perspective view of the communication unit 700 from which a communication unit cover member 730 is separated as viewed from the upper rear side. FIG. 25 is a perspective view of the communication unit 700 in a state in which the external communication connection portion 740 is moved to a fourth position P4. Note that the front, rear, left, and right of the communication unit 700 are based on the state of being attached to the rear surface portion 210 of the image sensor housing 200.

As illustrated in FIG. 19, the communication unit 700 includes the communication unit controller 720. The communication unit 700 is controlled by the communication unit controller 720. The communication unit 700 includes the communication unit connector 721, and the communication unit connector 721 is connected to the communication unit controller 720. When the communication unit 700 is attached to the image sensor, the communication unit connector 721 is coupled to the rear sensor connector 611. As the communication unit connector 721 and the rear sensor connector 611 are connected, the image sensor controller 21 of the image sensor 100 and the communication unit controller 720 of the communication unit 700 can communicate with each other.

That is, the communication unit connector 721 is coupled to the rear sensor connector 611 to enable data transmission between the image sensor controller 21 and the communication unit controller 720. In addition, power is supplied to the communication unit 700 from the power source 23 of the image sensor 100 by the connection between the rear sensor connector 611 and the communication unit connector 721. It is possible to reduce cables connecting the image sensor 100 and the communication unit 700 by directly connecting the communication unit connector 721 of the communication unit 700 and the rear sensor connector 611 of the image sensor 100.

As illustrated in FIGS. 19, 23, and 24, the communication unit 700 includes a communication unit housing 710, the communication unit cover member 730, and the external communication connection portion 740. The communication unit housing 710 is made of the same metal material as that of the image sensor housing 200, but is not limited thereto. The communication unit housing 710 is a rectangular parallelepiped box. A main substrate 750 and a sub-substrate 760 are provided in an internal space IS1 of the communication unit housing 710. The sub-substrate 760 is disposed in front of the main substrate 750. The communication unit connector 721 is attached to the sub-substrate 760. The communication unit connector 721 can be electrically connected to the rear sensor connector 611 provided in the image sensor 100. An IC (not illustrated) forming a controller that controls the communication unit 700 is attached to the main substrate 750 or the sub-substrate 760.

The communication unit housing 710 includes a front surface portion 711. The front surface portion 711 has a rectangular shape whose longitudinal direction is the up-down direction as viewed from the front side. The front surface portion 711 includes two contact protrusions 712 and two positioning protrusions 713. The two contact protrusions 712 protrude forward from both ends of the front surface portion 711 in the left-right direction. The lid attachment portion 215 of the image sensor 100 is provided with a contact surface 216. When the communication unit housing 710 is attached to the rear surface portion 210 of the image sensor housing 200, distal ends of the contact protrusions 712 come into surface contact with the contact surface 216. The screws Bt protrude from the distal ends of the contact protrusions 712. The communication unit 700 is firmly fixed to the image sensor 100 by screwing the screws Bt into screw holes 219 provided in the contact surface 216.

In addition, the front surface portion 711 is provided with a pressing protrusion 714 protruding forward. The communication unit connector 721 protrudes forward from the pressing protrusion 714. The pressing protrusion 714 presses the rear sensor connector sealing member 612 when the communication unit connector 721 is connected to the rear sensor connector 611.

The positioning protrusions 713 protrude forward from the front surface portion 711. The positioning protrusions 713 are provided at positions overlapping the positioning portions 214 in the front-rear direction when the communication unit 700 is disposed on the rear side of the image sensor 100. The two positioning protrusions 713 are provided on the front surface portion 711.

Similarly to the cover member 400, the communication unit cover member 730 is made of a material having a thermal conductivity lower than that of metal forming the communication unit housing 710, such as a silicon resin, an epoxy resin, or an ABS resin. As a result, even if the user's hand touches the communication unit 700, the sensible temperature of the user's hand can be suppressed to be low. As a result, the convenience of the user can be enhanced.

Four communication unit contact portions 717 protruding rearward are provided on the rear surface portion 716 of the communication unit housing 710. When the communication unit 700 is attached to the image sensor 100, positions of the communication unit contact portions 717 of the communication unit housing 710 are positions overlapping the sensor contact portion 211 of the rear surface portion 210 of the image sensor housing 200 in the front-rear direction. The communication unit cover member 730 includes contact portion through portions 731. The contact portion through portions 731 are formed at positions where the communication unit contact portions 717 can penetrate.

In a state in which the communication unit cover member 730 is attached to the communication unit housing 710, the communication unit 700 can be fixed using the attachment holes provided in the prop Pr. Therefore, it is not necessary to separately prepare a jig for attaching the communication unit 700 to the prop.

That is, the communication unit contact portion 717 of the communication unit 700 and the sensor contact portion 211 of the image sensor 100 are at positions overlapping one another in the front-rear direction. As a result, the center of the field of view of the image sensor 100 when the image sensor 100 to which the communication unit 700 is attached is attached to the prop Pr coincides with the center of the field of view when only the image sensor 100 is attached to the prop Pr. Therefore, it is not necessary to adjust the center of the field of view even if the communication unit 700 is attached. This also makes it possible to enhance the convenience of the user.

The external communication connection portion 740 includes an external communication connection portion housing 741. The external communication connection portion housing 741 has a trapezoidal columnar shape in a side view. The external communication connection portion housing 741 is made of the same metal material as that of the communication unit housing 710, but is not limited thereto.

The external communication connection portion housing 741 includes an opposing surface portion 742, and the opposing surface portion 742 opposes an inclined surface portion 719 provided at a lower end of the communication unit housing 710. The opposing surface portion 742 is coupled to the inclined surface portion 719 via a rotation shaft 743. The external communication connection portion 740 is rotatable about the rotation shaft 743.

The external communication connection portion housing 741 includes a connection surface portion 744 forming a surface not adjacent to the opposing surface portion 742. Two communication plugs 745 are attached to the connection surface portion 744. The communication plugs 745 are partially exposed to the outside of the external communication connection portion housing 741. A communication cable is connected to the communication plugs 745 and used for data communication. Note that the communication plugs 745 may be connectable to a cable that can perform both data communication and power supply. Note that the communication unit 700 of the present embodiment includes the two communication plugs 745, but is not limited thereto. For example, three or more communication plugs 745 may be provided. With a configuration including three or more communication plugs 745, it is also possible to adopt a connection method other than a daisy chain using the communication unit 700.

The communication plugs 745 are connected to at least one of the main substrate 750 and the sub-substrate 760 by an inner wire (not illustrated). The rotation shaft 743 has a cylindrical shape. The inner wire penetrates an internal space of the rotation shaft 743. The inner wire has an intermediate portion that is not fixed and has flexibility. Therefore, the connection state between the communication plugs 745 and the main substrate 750 or the sub-substrate 760 is maintained even when the external communication connection portion 740 rotates.

The external communication connection portion 740 includes an external connection portion cover 746. The external connection portion cover 746 covers a part of the external communication connection portion housing 741. The external connection portion cover 746 is made of, for example, a material having a thermal conductivity lower than that of metal forming the external communication connection portion housing 741, such as a silicon resin, an epoxy resin, or an ABS resin. As a result, it is difficult for the user's hand to directly touch the external communication connection portion 740. In addition, the sensible temperature of the user can be suppressed to be low.

In the communication unit 700, the external communication connection portion 740 is rotated about the rotation shaft 743 to turn to a third position P3 at which the communication plugs 745 extend downward (see FIG. 23 and the like) and a fourth position P4 at which the communication plugs 745 extend rearward. In this manner, the degree of freedom of wiring of a cable connected to the communication plugs 745 can be increased. In addition, even in a case where there is an obstacle below the communication unit 700, the communication plugs 745 can be disposed at positions avoiding the obstacle by rotating the external communication connection portion 740.

Next, the attachment of the communication unit 700 to the image sensor 100 will be described. When the two positioning protrusions 713 are inserted into the positioning portions 214, the communication unit 700 is positioned with respect to the image sensor 100. As a result, the communication unit connector 721 is inserted into the rear sensor connector hole 213.

The contact surface 216 of the rear surface portion 210 of the image sensor housing 200 is provided with screw holes for fixing the rear sensor connector lid 613. When the communication unit 700 is positioned with respect to the image sensor 100, the screws Bt protruding from the distal ends of the contact protrusions 712 overlap the screw holes 219 provided in the contact surface 216 of the image sensor housing 200 in the front-rear direction.

The screws Bt protruding from the distal ends of the contact protrusions 712 are screwed into the screw holes 219 provided in the contact surface 216. As a result, the communication unit 700 is firmly fixed to the image sensor 100. In addition, the distal ends of the contact protrusions 712 and the contact surface 216 of the rear surface portion 210 of the image sensor housing 200 are reliably brought into surface contact with each other. Further, the sensor contact portions 211 of the rear surface portion 210 of the image sensor housing 200 are also in contact with the front surface portion 711 of the communication unit housing 710. As a result, the heat of the image sensor housing 200 is efficiently conducted to the communication unit housing 710. When a certain period of time elapses in this state, the temperature of the image sensor housing 200 and the temperature of the communication unit housing 710 are made uniform.

When the communication unit 700 is attached to the image sensor 100, the pressing protrusion 714 presses the rear sensor connector sealing member 612. As a result, the rear sensor connector sealing member 612 is brought into close contact with the rear surface portion 210 of the image sensor housing 200 and the front surface portion 711 of the communication unit 700. As a result, foreign matter such as water, dirt, and dust is suppressed from entering the internal spaces IS and ISI from a gap between the rear surface portion 210 of the image sensor housing 200 and the front surface portion 711 of the communication unit housing 710.

As illustrated in FIGS. 21, 22, and the like, the rear sensor connector 611 of the image sensor 100 and the communication unit connector 721 of the communication unit 700 are electrically connected. As a result, the image sensor controller 21 of the image sensor 100 and the communication unit controller 720 of the communication unit 700 can communicate with each other. As a result, the image sensor 100 can communicate with an external device using the communication unit 700.

In addition, power can be supplied from the power source 23 of the image sensor 100 to the communication unit 700 by the connection between the rear sensor connector 611 and the communication unit connector 721. Note that power may be supplied to the communication unit 700 via a communication cable connected to the communication plugs 745 by using the communication cable capable of both data communication and power supply.

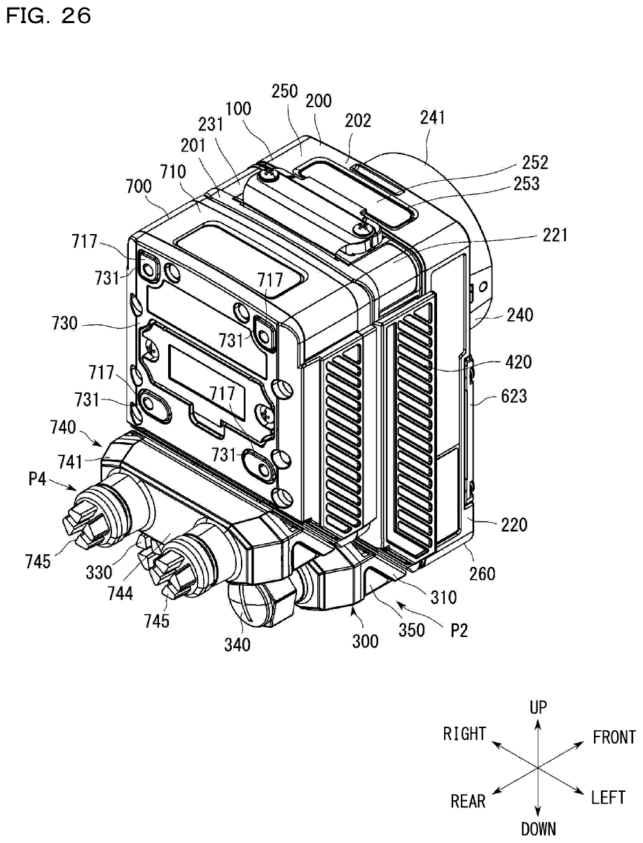

In addition, the communication unit 700 in a state in which the external communication connection portion 740 is rotated from the third position P3 to the fourth position P4 (see FIG. 25) can be attached to the image sensor 100. At this time, the external connection portion 300 of the image sensor 100 may be rotated from the first position PI to the second position P2 (see FIG. 18) (see FIG. 26). FIG. 26 is a perspective view illustrating a state in which the image sensor 100 in which the external connection portion 300 is moved to the second position P2 is combined with the communication unit 700 in which the external communication connection portion 740 is moved to the fourth position P4.

With such a configuration, cables can be connected to the external connection plugs 330 and 340 and the communication plugs 745 even if there is a structure below the image sensor 100 and the communication unit 700 attached to the prop Pr. That is, the degree of freedom of installation of the image sensor 100 in which the communication unit 700 is disposed increases, and the convenience of the user is improved.

The use of the communication unit 700 as described above can reduce cables connecting the communication unit 700 and the image sensor 100. In addition, the heat of the image sensor 100 can be conducted to the prop Pr via the communication unit 700, the temperature rise in each of the image sensor 100 and the communication unit 700 can be suppressed.

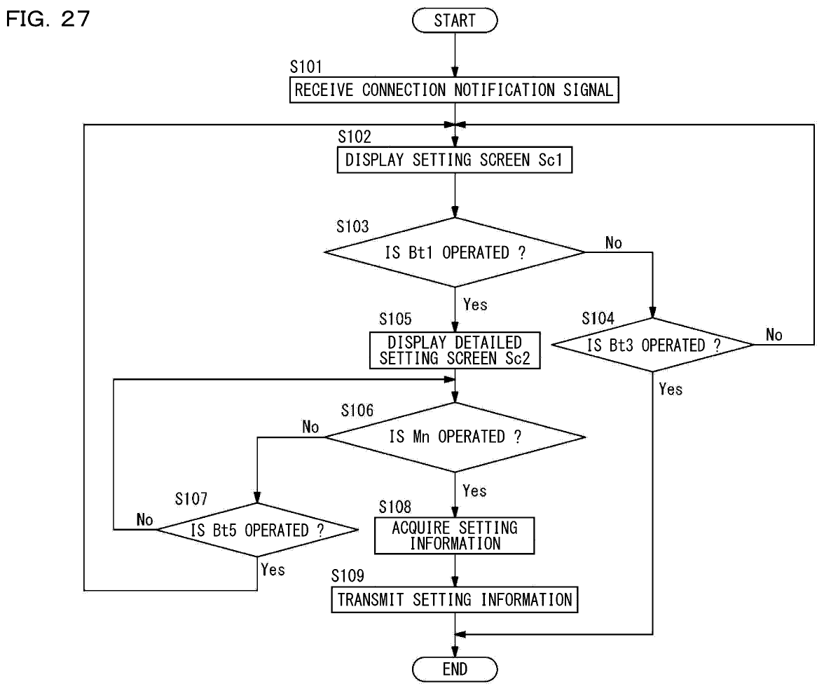

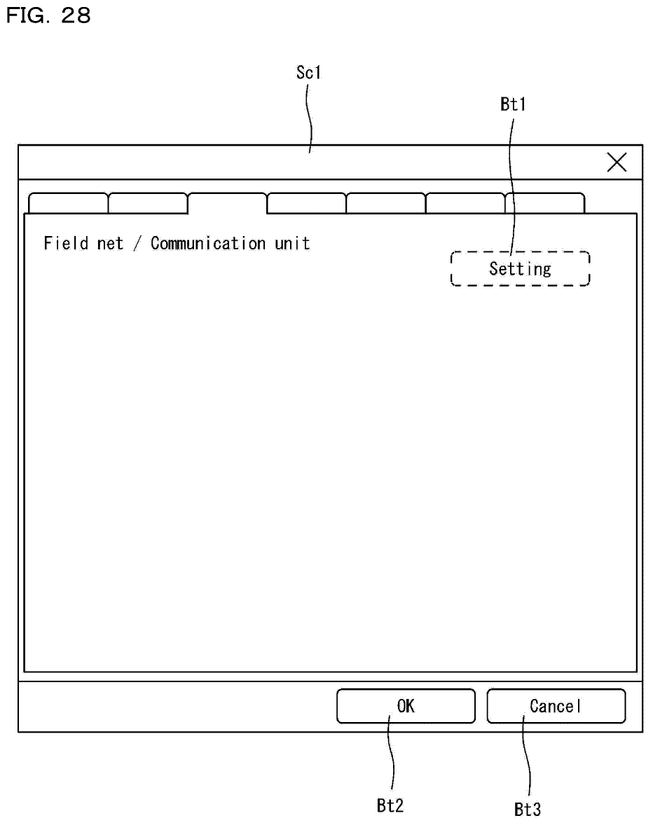

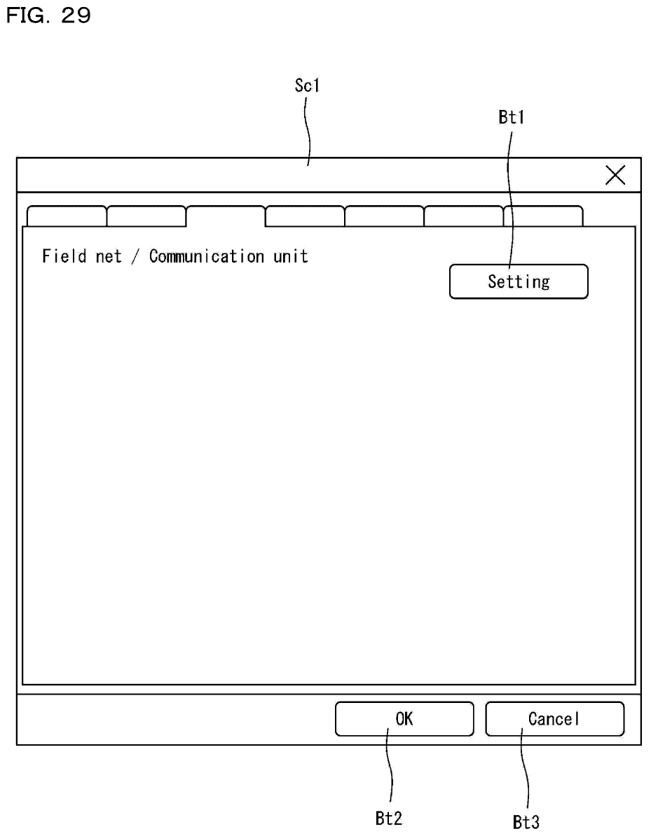

Here, the setting of the communication unit 700 will be described. FIG. 27 is a flowchart of an operation of setting the communication unit 700. FIG. 28 is a view illustrating a setting screen Sc1 displayed on the display device 4 when extended setting of the image sensor 100 is performed. FIG. 29 is a view illustrating the setting screen Sc1 when the communication unit 700 is connected. FIG. 29 is a view illustrating a detailed setting screen Sc2 used when the setting of the communication unit 700 is performed.

In the image sensor 100, an extended function can be set. The extended function is set by displaying a setting screen on the display device 4 and operating the touch panel 4a, the keyboard 3a, the mouse, or the like. Examples of the setting screen displayed on the display device 4 include the setting screen Sc1 illustrated in FIG. 28.

The setting screen Sc1 illustrated in FIG. 28 includes a plurality of extended setting tabs such as Device settings, Image/Result output, and Utilities. Each of the tabs is provided with a setting item corresponding to the extended function of the image sensor 100.

As illustrated in FIGS. 28 and 29, the setting of the communication unit 700 can be executed on the setting screen Sc1 on which the “Utilities” tab is active. The setting screen Sc1 on which the “Utilities” tab is active includes a setting item of Field net/Communication unit. The setting item of Field net/Communication unit includes a setting button Bt1.

In a case where the setting of the communication unit 700 is disabled, the setting button Bt1 is in an inactive (inoperable) state as illustrated in FIG. 28. On the other hand, in a case where the setting of the communication unit 700 is enabled, the setting button Bt1 is in an active (operable) state as illustrated in FIG. 29. That is, the setting screen Sc1 has a configuration of receiving an operation on the setting button Bt1 only when the setting of the communication unit 700 is enabled. Note that only items that can be set can be operated even in the case of setting other extended functions. In addition, it may be configured to make only items that can be set active in a case where there are a plurality of setting items.

An OK button Bt2 and a cancel button Bt3 are provided in a lower part of the setting screen Sc1. When the OK button Bt2 is operated after the setting button Bt1 is operated, the operation of the setting button Bt1, that is, the operation on the setting screen Sc1 becomes valid. In addition, when the cancel button Bt3 is operated after the setting button Bt1 is operated, the operation of the setting button Bt1, that is, the input on the setting screen Sc1 becomes invalid. The operation of making the setting operation valid or invalid is similar in other setting screens.

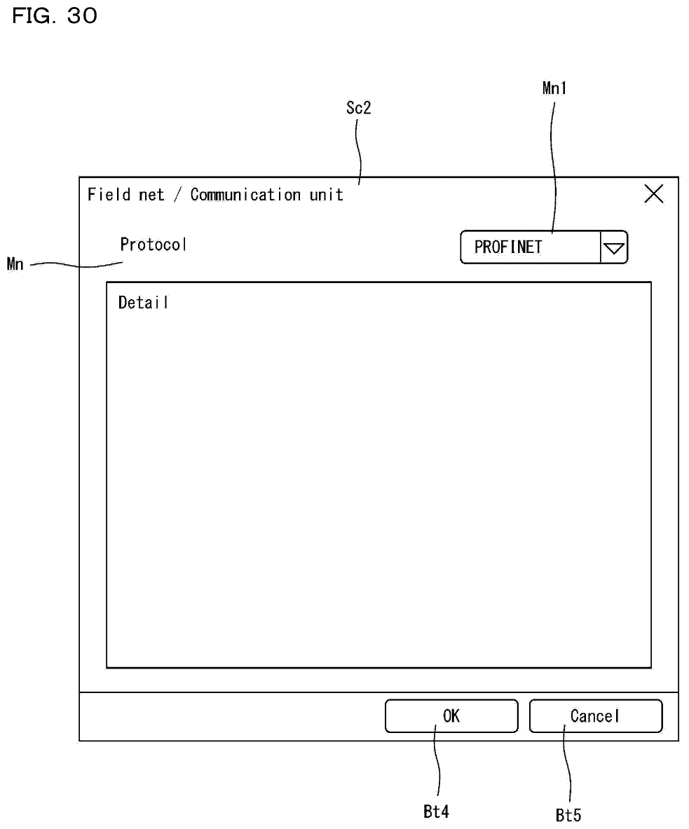

For example, it is assumed that the OK button Bt2 is operated after the setting button Bt1 is operated on the setting screen Sc1. At this time, the image sensor controller 21 transmits a control signal for displaying the detailed setting screen Sc2 (see FIG. 30) to the display of the display device 4.

As illustrated in FIG. 30, the detailed setting screen Sc2 includes a setting item Mn. The setting item Mn on the detailed setting screen Sc2 illustrated in FIG. 30 is an item for selecting a communication protocol. In the detailed setting screen Sc2, the setting item Mn may be a setting item other than the communication protocol, or may have a plurality of setting items. The setting item Mn is provided with a setting operation section Mn1. The setting operation section Mn1 is a pull-down menu selectable from a plurality of communication protocols in the detailed setting screen Sc2, but is not limited thereto. A configuration in which the user can input characters may be adopted. Similarly to the setting screen Sc1, the detailed setting screen Sc2 includes an OK button Bt4 and a cancel button Bt5.

In the image sensor 100, the image sensor controller 21 has a function of automatically displaying a setting screen of an extended function on the display device 4 when the setting of the extended function is required. For example, when the communication unit 700 is connected to the image sensor 100, the setting screen Sc1 is displayed on the display device 4. More specifically, when the communication unit 700 is connected to the image sensor 100, the communication unit controller 720 transmits a connection notification signal to the image sensor 100. The connection notification signal includes information for specifying that a connected device is the communication unit 700. Therefore, when receiving the connection notification signal, the image sensor controller 21 sends a control signal for displaying the setting screen Sc1 (see FIG. 29) to the display device 4. Then, the image sensor controller 21 receives input of an operation by the user.

The above-described operation will be described with reference to the drawings. As illustrated in FIG. 27, when the image sensor controller 21 receives the connection notification signal (step S101), the image sensor controller 21 sends the control signal to cause the display device 4 to display the setting screen Sc1 (step S102).

Then, the image sensor controller 21 confirms whether or not the setting button Bt1 is operated (step S103). Whether or not the setting button Bt1 is operated and the operation is valid is as described above. In a case where the image sensor controller 21 does not confirm the operation of the setting button Bt1 (No in step S103), the image sensor controller 21 confirms whether or not the cancel button Bt3 is operated (step S104). In a case where the image sensor controller 21 does not confirm the operation of the cancel button Bt3 (No in step S104), processing returns to step S103, and the image sensor controller 21 continues the processing.

In a case where the image sensor controller 21 confirms the operation of the cancel button Bt3 (Yes in step S104), the image sensor controller 21 ends the setting processing. In addition, in a case where the image sensor controller 21 confirms the operation of the setting button Bt1 (Yes in step S103), the image sensor controller 21 transmits the control signal for displaying the detailed setting screen Sc2 to the display device 4 (step S105). As a result, the detailed setting screen Sc2 is displayed on the display device 4 (see FIG. 30).

The image sensor controller 21 confirms whether or not the setting item Mn is operated (step S106). In a case where the image sensor controller 21 does not confirm the operation of the setting item Mn (No in step S106), the image sensor controller 21 confirms whether or not the cancel button Bt5 is operated (step S107). In a case where the image sensor controller 21 does not confirm the operation of the cancel button Bt5 (No in step S107), the processing returns to step S106, and the image sensor controller 21 continues the processing.

In a case where the image sensor controller 21 confirms the operation of the cancel button Bt5 (Yes in step S107), the image sensor controller 21 returns to step S102 and executes display of the setting screen Sc1. Note that the image sensor controller 21 may end the setting processing when the image sensor controller 21 confirms the operation of the cancel button Bt5 in step S107.

In a case where the image sensor controller 21 confirms the operation of the setting item Mn (Yes in step S106), the image sensor controller 21 acquires setting information set on the detailed setting screen Sc2 (step S108). Then, the image sensor controller 21 transmits the acquired setting information to the communication unit controller 720 of the communication unit 700 (step S109). The communication unit controller 720 of the communication unit 700 executes setting of a communication protocol based on the setting information acquired from the image sensor controller 21 of the image sensor 100.

As described above, when the communication unit 700 is connected to the image sensor 100, the user can perform the setting of the communication unit 700 using the PC 3 and the display device 4 connected to the image sensor 100. As a result, there is no need to provide an input unit and a display unit for the setting of the communication unit 700, and the communication unit 700 can be configured to be simple and downsized.

In the image inspection system S, the image sensors 100 can be connected to each other using the communication unit 700 by attaching the communication unit 700 to the image sensors 100. Hereinafter, connection examples of the image sensors 100 will be described.

First, a communication network will be described. Communication networks of a factory in which the image inspection system S is used are often classified into two communication networks of an IT network 6 and an OT network 7. The IT network 6 is, for example, a network for performing data communication of processing data and the like captured and processed by the image sensor 100. The IT network 6 is sometimes connected to a communication network connected to an external server (not illustrated) such as the Internet.

The OT network 7 is a network (for example, Profinet) in the factory. The OT network 7 is used to transmit, to the PLC 5, for example, a determination result (for example, binary data notifying good and bad) of quality determination of processing data obtained by performing predetermined processing on an image by the image sensor controller 21 after the image is captured by the image sensor 100. In addition, the OT network 7 also transmits data related to an operation of an external device such as the PLC 5. In the OT network 7, data necessary for operations of a manufacturing apparatus and a manufacturing line is communicated.

Typically, the capacity of data transmitted through the IT network 6 is larger than the capacity of data transmitted through the OT network 7. Therefore, in general, a communication speed of the IT network 6 is higher than a communication speed of the OT network 7.

### First Network Connection Example

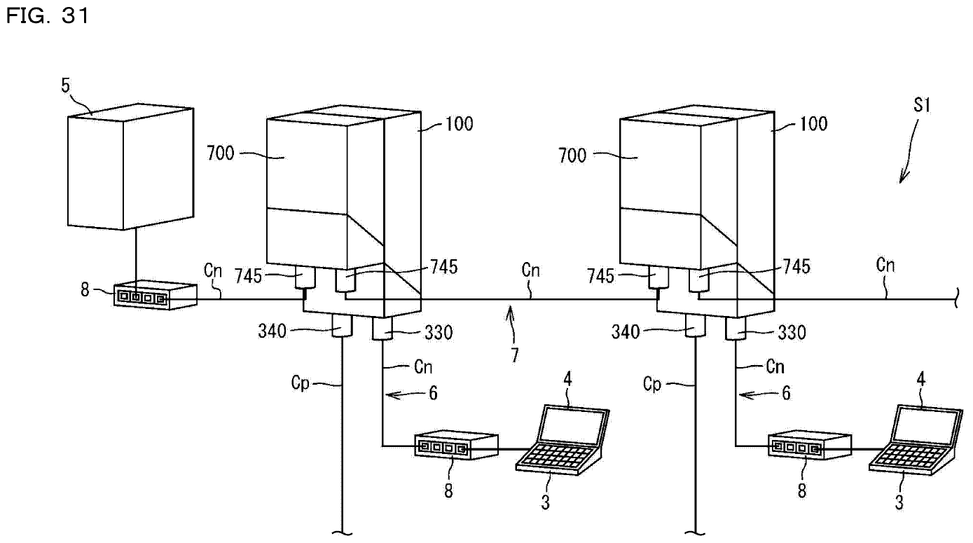

FIG. 31 is a schematic diagram of an image inspection system S1 connected in a first network connection example. As illustrated in FIG. 31, the image inspection system SI includes a plurality of the image sensors 100, and the communication units 700 are attached to the image sensors 100, respectively. Then, the communication units 700 are connected in a daisy chain by connecting the respective communication plugs 745 to each other using the communication cable Cn. The communication unit 700 is connected to the OT network 7 via the communication cable Cn connected to the communication plugs 745. That is, the image sensor 100 is connected to the OT network 7 via the communication unit 700. Then, the PLC 5 is connected to the OT network 7. More specifically, it can be said that the communication unit 700 is a device relaying the OT network 7.

In addition, the power cable Cp is connected to the external connection plug 340 of each of the image sensors 100, and power is supplied to the image sensor 100. Power is supplied to the communication unit 700 from the power source 23 of the image sensor 100 by the connection between the communication unit connector 721 and the rear sensor connector 611. The external connection plug 330 of each of the image sensors 100 is connected to the IT network 6 by the communication cable Cn. The PC 3 and the display device 4 are connected to the communication cable Cn.

That is, the image sensor 100 is connected to the PC 3 and the display device 4 connected to the IT network 6 via the external connection plug 330. In addition, the image sensor 100 is connected to the PLC 5 connected to the OT network 7 via the communication unit 700. As described above, the connection to the IT network 6 and the connection to the OT network 7 can be separated by using the image inspection system S1, and it is possible to enhance the security of the OT network 7. Note that the PLC 5 is connected to the OT network 7 via the communication router 8.

### Second Network Connection Example

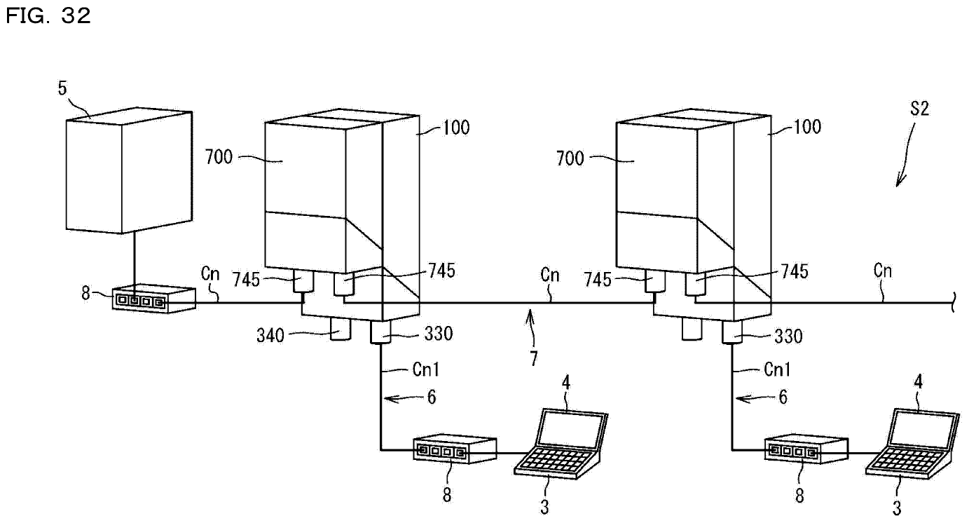

An image inspection system S2 adopting a second network connection example will be described with reference to the drawing. FIG. 32 is a schematic diagram of the image inspection system S2 connected in the second network connection example. In the image inspection system S2 illustrated in FIG. 32, the image sensor 100 is compatible with a communication line (PoE) that enables power supply. Therefore, in the image inspection system S2, power of the image sensor 100 is supplied via a communication cable Cn1 that enables power supply and is connected to the IT network 6.

With such a configuration, it is not necessary to connect a power cable to the external connection plug 340 of the image sensor 100, and it is possible to reduce wiring (hereinafter, referred to as wiring saving).

### Third Network Connection Example

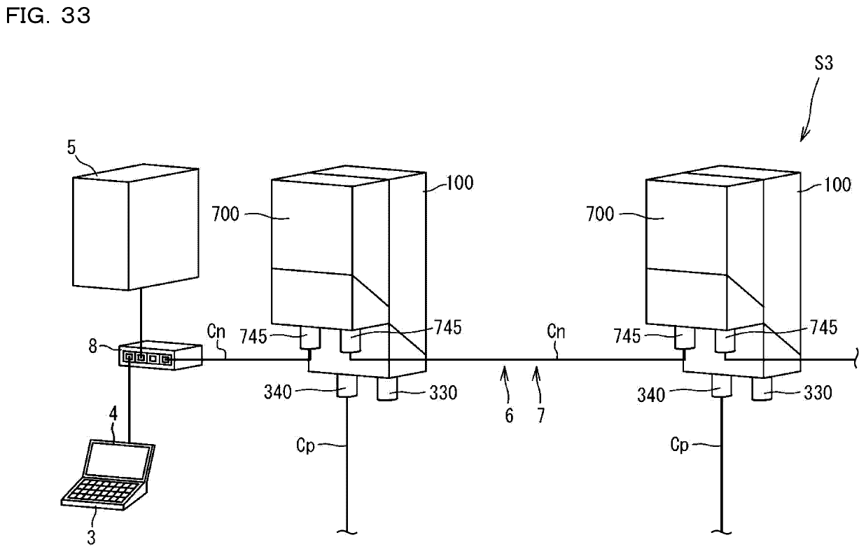

An image inspection system S3 adopting a third network connection example will be described with reference to the drawings. FIG. 33 is a schematic diagram of the image inspection system S3 connected in the third network connection example.

Depending on a manufacturing apparatus and a manufacturing line, it may be unnecessary to separate the OT network 7 and the IT network 6 for security. In a network under such a condition, the IT network 6 and the OT network 7 can share the communication cable Cn. Therefore, a function as an OT network port and a function as an IT network port are allocated to the communication unit 700. As a result, the IT network 6 and the OT network 7 can be configured by a daisy chain of the communication units 700.

As illustrated in FIG. 33, in the image inspection system S3, the PC 3, the display device 4, and the PLC 5 are connected to one end of the daisy chain of a plurality of the communication units 700 via the communication router 8. The high-speed IT network 6 is used for communication between the image sensor controller 21 and each of the PC 3 and the display device 4 via the communication unit 700, and pieces of information such as an inspection result and a control signal corresponding to the inspection result from the image sensor controller 21 are transmitted to the PLC 5 via the OT network 7.

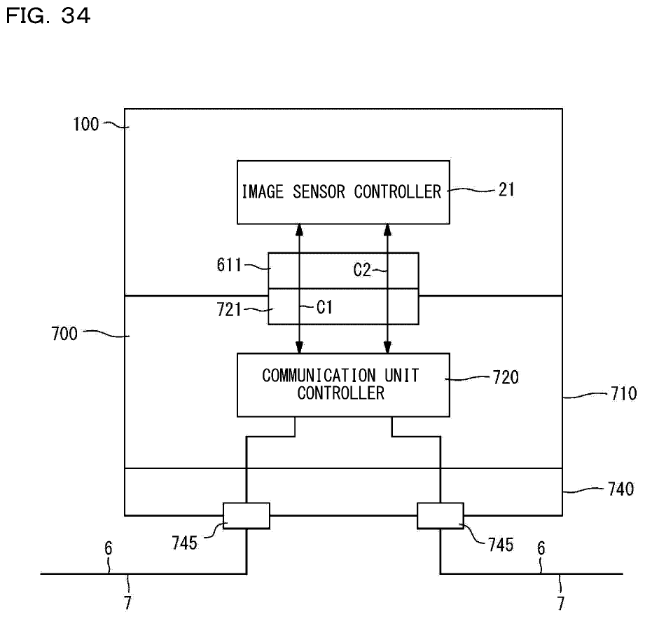

FIG. 34 is a block diagram illustrating communication between the image sensor controller 21 of the image sensor 100 and the communication unit controller 720 of the communication unit 700. As illustrated in FIG. 34, in the image inspection system S3, the connection to the IT network 6 and the connection to the OT network 7 are performed by the communication unit 700. Therefore, transmission and reception of data transmitted and received through the IT network 6 and data transmitted and received through the OT network 7 are also performed between the image sensor controller 21 of the image sensor 100 and the communication unit controller 720 of the communication unit 700.

Therefore, as illustrated in FIG. 34, data having a large capacity, such as image data and processing data, and data (referred to as IT data) preferably having a small delay, such as configuration data, are transmitted between the image sensor controller 21 and the communication unit controller 720 in the image inspection system S3. Similarly, data (referred to as OT data) having a small capacity and allowed to have a communication delay to some degree as compared with the above-described IT data, such as an inspection result of image data of the image sensor controller 21 and a quality determination result, is transmitted between the image sensor controller 21 and the communication unit controller 720.

In such a configuration, when communication speeds of all pieces of data are set based on the IT data between the image sensor controller 21 and the communication unit controller 720, there is a case where an excessive speed is set for transmission of the OT data. In addition, when the communication speeds of all the pieces of data are set based on the OT data, it takes a lot of time for transmission of the IT data, and it is not possible to cope with data that requires quick data transmission. Therefore, in the image inspection system S3, the image sensor controller 21 and the communication unit controller 720 are connected by a first line C1 and a second line C2. The first line C1 is a line that executes transmission of the IT data. The second line C2 is a line that executes transmission of the OT data.

Note that the first line C1 and the second line C2 may be communications using a protocol that apparently realizes a plurality of communications having different communication speeds. In addition, the rear sensor connector 611 and the communication unit connector 721 may include the first line C1 and the second line C2 that are physically independent. In this case, communication sections connected to the first line C1 and the second line C2 may be different communication sections. As described above, the first line C1 that transmits and receives the IT data and the second line C2 that transmits and receives the OT data are physically separated, so that communication conflict is suppressed.

As described above, the IT data and the OT data can be efficiently transmitted by connecting the image sensor controller 21 of the image sensor 100 and the communication unit controller 720 of the communication unit 700 by a plurality of lines having different communication speeds.

### Fourth Network Connection Example

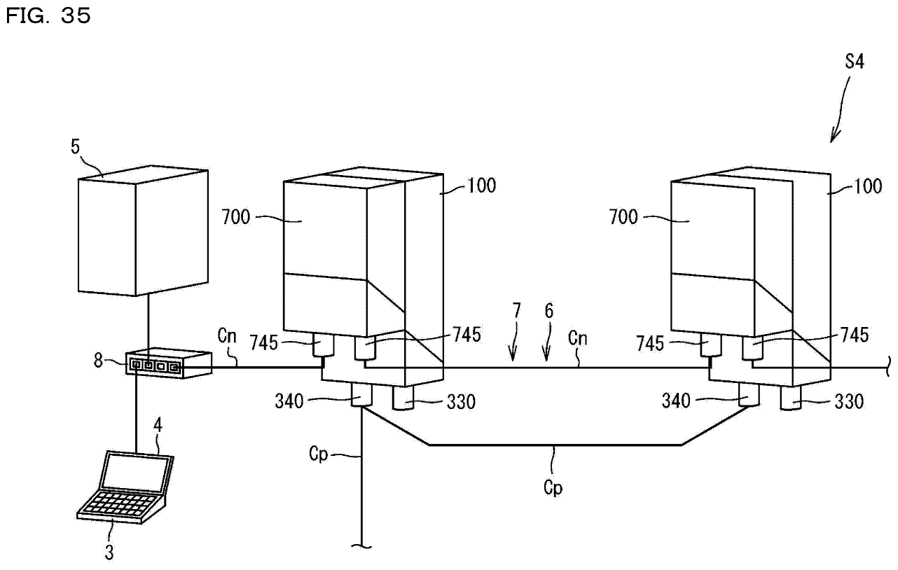

An image inspection system S4 adopting a fourth network connection example will be described with reference to the drawing. FIG. 35 is a schematic diagram of the image inspection system S4 connected in the fourth network connection example. As illustrated in the image inspection system S4, the image sensors 100 may be connected in a daisy chain by the external connection plugs 340 of the image sensors 100 and the power cable Cp. In this manner, the power cable Cp and the communication cable Cn can be wired separately, and noise or the like with respect to the communication cable Cn caused by the power cable Cp can be suppressed.

### Fifth Network Connection Example

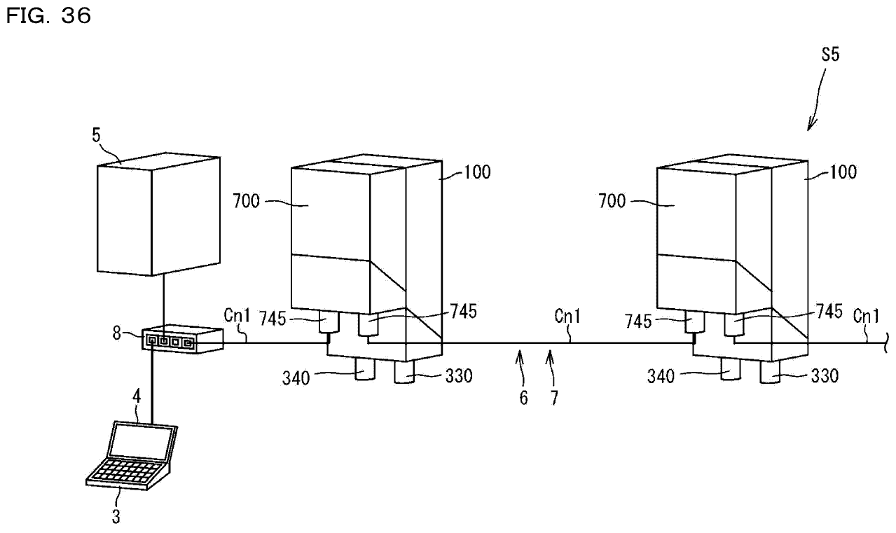

An image inspection system S5 adopting a fifth network connection example will be described with reference to the drawing. FIG. 36 is a schematic diagram of the image inspection system S5 connected in the fifth network connection example. As illustrated in the image inspection system S5, the IT network 6, the OT network 7, and power supply can be achieved by one network by providing the communication unit 700 with a function of receiving the power supply through the communication cable Cn1 using the communication cable Cn1 that enables the power supply and connecting the communication units 700 in a daisy chain. This enables further wiring saving.

### <Others>

Note that, in addition to the above-described embodiment, various alterations can be applied to various technical features disclosed in the present specification within a scope not departing from the spirit of the technical creation. That is, it should be considered that the above-described embodiment is illustrative in all respects and not restrictive. In addition, the technical scope of the invention is defined by the claims, and should be understood to include all modifications falling within the meaning and scope equivalent to the claims.

What is claimed is:

1. An image sensor configured to capture an image of an object to be inspected, the image sensor comprising:
an imaging unit including an imaging sensor;
a control unit configured to process a captured image captured by the imaging unit;
an image sensor housing made of metal, configured to house the imaging unit and the control unit and be attachable to a prop; and
a cover member made of a material having a thermal conductivity lower than a thermal conductivity of the image sensor housing and configured to cover at least a part of each of a pair of side surfaces, which are surfaces intersecting a front surface and facing in mutually different directions, the front surface being a surface including an imaging hole configured to guide light outside the image sensor housing to the imaging sensor,
wherein the image sensor housing includes a contact portion that comes into contact with the prop when the image sensor housing is attached to the prop.

2. The image sensor according to claim 1, wherein the cover member covers at least a part of a rear surface on a side opposite to the front surface of the image sensor housing.

3. The image sensor according to claim 1, wherein at least a part of the contact portion is fixed to the prop.

4. The image sensor according to claim 1, wherein the cover member includes a contact portion through-hole through which the contact portion penetrates.

5. The image sensor according to claim 1, further comprising:
a first thermally conductive member in contact with a heating element disposed inside the image sensor housing; and
a second thermally conductive member in contact with the first thermally conductive member and the image sensor housing,
wherein the first thermally conductive member has a higher thermal conductivity than the second thermally conductive member, and
the second thermally conductive member has an insulating property.

6. The image sensor according to claim 1, wherein the cover member is configured not to cover the front surface of the image sensor housing.

7. The image sensor according to claim 5, wherein the heating element is a semiconductor element and includes an inference accelerator.

8. The image sensor according to claim 1, further comprising an external connection plug which has a portion exposed to an outside of the image sensor housing and to which an external cable is connectable, wherein a heat insulator is disposed between the external connection plug and the image sensor housing.

9. The image sensor according to claim 2, further comprising:
a sensor connector hole formed on the rear surface of the image sensor housing to overlap a sensor connector disposed inside the image sensor housing in a front-rear direction;
a sensor connector sealing member attached adjacent to the sensor connector hole; and
a detachable sensor connector lid configured to cover the sensor connector hole,
wherein the sensor connector lid includes a pressing portion capable of pressing the sensor connector sealing member when the sensor connector lid is attached to the rear surface, and
the cover member includes a lid through-hole that allows passage of the sensor connector lid when the sensor connector lid is attached to and detached from the image sensor housing in a state in which the cover member is attached to the image sensor housing.

10. An image inspection system comprising:
the image sensor according to claim 1; and
the prop capable of supporting the image sensor housing,
wherein the prop is made of aluminum or an alloy containing aluminum.

11. An image inspection system comprising:
the image sensor according to claim 9; and
an external unit including a communication unit connector connectable to the sensor connector,
wherein the external unit includes an external unit housing with which the contact portion is capable of contact, and
the external unit housing includes a pressing portion capable of pressing the sensor connector sealing member.

12. The image inspection system according to claim 11, wherein
the external unit is attached to the rear surface of the image sensor housing,
the external unit includes a contact protrusion that comes into contact with at least a part of the rear surface, and
the rear surface of the image sensor housing includes a contact surface with which a distal end of the contact protrusion is capable of surface contact.

13. The image inspection system according to claim 11, wherein
the external unit is attached to the rear surface of the image sensor housing, and
the external unit includes an external contact portion on a surface on a side opposite to a surface opposing the rear surface of the image sensor housing at a position overlapping the contact portion of the image sensor housing in a connection direction between the image sensor housing and the external unit.

14. The image inspection system according to claim 11, wherein the external unit is a communication unit to which an information communication cable is connectable.

15. The image inspection system according to claim 11, wherein the external unit is an illumination unit capable of irradiating the object with illumination light.
